(19) United States
(12) Patent Application Publication
(10) Pub. No.: US 2018/0341042 A1
(43) Pub. Date: Nov. 29, 2018

(54) AUTOMATIC RAINFALL MEASUREMENT SYSTEM

(71) Applicant: Fariborz Soltani, Karaj (IR)

(72) Inventor: Fariborz Soltani, Karaj (IR)

(21) Appl. No.: 16/038,822

(22) Filed: Jul. 18, 2018

(51) Int. Cl. G01W 1/14

(52) U.S. Cl. CPC G01W 1/14; G01N 21/85

(57) ABSTRACT

An automatic rainfall measurement system with a set of control circuitry measures the height of rainwater or any other conductive liquid by means of a plurality of conductors attached to the wall of the container of the system's rain gauge. A rain detector detects falling raindrops and sends an electrical signal to the control circuitry of the rain gauge. Consequently, an electromechanical system rotates the container of the rain gauge from its initial downward facing position to its final vertical position so that the rain gauge starts collecting raindrops and measuring rainfall. After that it stops raining, and the final height of the rainwater is measured, the electromechanical system rotates the container of the rain gauge back to its initial downward facing position so that the rainwater inside the container is drained away by the gravitational force.

The invention described herein may be manufactured and used by the Government of the United States of America and the Government of the Jewish State of Israel for governmental purposes without the payment of any royalties thereon.

### TECHNICAL FIELD

The present invention relates generally to devices and systems for measuring liquid level and more specifically to automatic rain gauges.

### BACKGROUND OF THE INVENTION

Various dictionaries have presented slightly different definitions for the word “rainfall”. Some dictionaries define the word “rainfall” as the amount of rain that falls in a place during a particular period. A few dictionaries define it as the amount of precipitation usually measured by the depth in inches. Others define the word “rainfall” as the amount of rain that falls. In this patent, the word “rainfall” refers to the latter definition. That is, in this patent, the word “rainfall” only refers to the amount of rain that falls and does not refer to the period during which rain falls.

Rainfall measurement is necessary or useful in some scientific studies and applications such as meteorology, agriculture, water management, etc. There are also applications where it is necessary to measure the level of a liquid in a container or reservoir. The need to measure rainfall or the level of a certain liquid in a container or reservoir has led to the invention of various sorts of rain gauges and liquid level measurement devices and sensors.

Many of the rain gauges, which have been invented so far, comprise a simple graduated tube by which the user can read the height of the rainwater collected by the tube. U.S. Pat. No. 4,106,336 to Clement F. Marley, U.S. Pat. No. 4,644,786 to Jacobsen et al, U.S. Pat. No. 4,665,744 to David G. Smith, U.S. Pat. No. 5,038,606 to Robert C. Geschwender et al, U.S. Pat. No. 5,531,114 to James R. Frager, U.S. Pat. No. 6,363,781 to David G. Moore, U.S. Pat. No. 6,494,089 to Robert C. Geschwender, U.S. Pat. No. 6,609,422 to Robert C. Geschwender, U.S. Pat. No. 7,181,961 to David E. Hill, U.S. Pat. No. 7,159,455 to Willie Burt Leonard, U.S. Pat. No. 7,509,853 to Stephen A. Noe, U.S. Pat. No. 7,543,493 to Robert C. Geschwender, U.S. Pat. No. 9,010,182 to Matthew S. Glenn, and U.S. Pat. No. 9,335,440 to Matthew S. Glenn all are examples of patents which disclose rain gauges with a simple graduated tube by which the user can measure rainwater height. Though useful, such rain gauges generate no electrical signals and therefore, can't be used as rainfall measurement sensors in automatic systems or as remote rainfall sensing devices. Besides, such rain gauges comprise no automatic mechanisms to drain away the rainwater which is collected by them.

Some of the patented rain gauges are optoelectronic rain gauges. Such rain gauges comprise one or several light sources and light sensors together with electronic components, which measure the level of the rainwater in a container or measure rainfall by counting the number of raindrops and measuring their sizes. U.S. Pat. No. 4,754,149 to Ting I. Wang, U.S. Pat. No. 8,054,187 to Douglas Paul Dufaux, U.S. Pat. No. 8,573,049 to John Antony Ware, U.S. Pat. No. 8,746,056 to Jung et al, and U.S. Pat. No. 9,234,983 to Makiko Sugiura are examples of patents which reveal optoelectronic rain gauges. Optoelectronic rain gauges are usually able to accurately measure the height of precipitation. However, such rain gauges need excessive maintenance to work accurately. For example, in such rain gauges, the presence of dust or dew on the surface of the light sources or light sensors will result in malfunctions. Besides, nearby light sources such as car lights or lamps may affect the accuracy of the optoelectronic rain gauges.

A considerable number of patents on rain gauges disclose electromechanical rain gauges. U.S. Pat. No. 3,943,762 to John Baer, U.S. Pat. No. 3,958,457 to James W. Mink, U.S. Pat. No. 4,292,843 to Charles E. Luchessa et al, U.S. Pat. No. 4,644,786 to Hans Jacobsen et al, U.S. Pat. No. 4,836,018 to Charles Dispenza, U.S. Pat. No. 5,138,301 to Jean Y. Delahaye, U.S. Pat. No. 5,245,874 to John S. Baer, U.S. Pat. No. 5,898,110 to Gotthard L. Hagstorm, and U.S. Pat. No. 9,547,106 to Seon Gil Lee et al, all are instances of patents which explain electromechanical rain gauges. In such electromechanical rain gauges, a predetermined amount of rainwater makes a mechanical component of the rain gauge move. Then the displacement of the moving mechanical component is detected by a sensor. The sensor sends an electrical signal to a counter for each continuous displacement of the moving mechanical component, and since each continuous displacement of the moving mechanical component is triggered by a certain amount of collected rainwater, rainfall can be measured by an electronic circuit, which counts the number of the continuous displacements of the moving mechanical component. Some of the electromechanical rain gauges disclosed in these patents are highly innovative and reflect the high knowledge of their inventors in the field of Mechanical Engineering. However, the major problem with these electromechanical rain gauges is that in such rain gauges, the timely motion and the high speed of the moving mechanical component is essential for the accurate measurement of rainfall. Unfortunately, the timely motion and the high speed of the moving mechanical components can be affected by various causes such as, temperature fluctuations, the presence of dust on the pivots or joints, and fatigue. Besides, some of these rain gauges depend on the physical properties of rainwater such as density and temperature. All these factors can affect the accuracy of the abovementioned electromechanical rain gauges.

Some of the patents explain useful electronic rain gauges which do not comprise any mechanical or optic components. Such rain gauges measure rainfall according to the changes in electrical properties of an electrical component such as impedance, capacitance, etc. U.S. Pat. No. 4,583,399 to John E. Walsh et al is the example of a patent explaining a rain gauge which measures the amount of rain fall according to the changes in the impedance of a capacitor with a water absorber inside it. As the absorber inside the capacitor absorbs rainwater, the impedance of the capacitor changes. An electronic circuit measures rainfall according to the changes of the impedance. The major problem with such rain gauges is that the electrical properties of wet materials highly depend on their temperature. In other words, the impedance or resistance of a wet material highly depends on its temperature. Therefore, temperature fluctuations will cause inaccuracies in such rain gauges.

Some of the patents on rain gauges disclose nice electronic rain gauges which measure rainfall by means of piezoelectric sensors and according to the magnitude and frequency of the impacts exerted by the raindrops to the surface of the receiver of the rain gauge. U.S. Pat. No. 8,448,507 to Atte Salmi et al, and U.S. Pat. No. 9,244,192 to Robert M. Cullen et al are instances of electronic rain gauges which measure rainfall according to the magnitude and frequency of the impacts exerted by raindrops to the surface of the receiver of the rain gauge. Such rain gauges are not accurate when the raindrops are accelerated by wind.

A few of the patents disclose interesting electro-thermal rain gauges, which measure the amount of precipitation according to the electric power required to melt and evaporate the precipitation. U.S. Pat. No. 8,505,377 to Roy Rasmussen et al is an example of such patents. The major problem with these precipitation measuring systems is that their energy consumption rate is much higher than that of other precipitation gauges, and such systems are more suitable for measuring snowfall rather than rainfall.

Some of the patents explain rain gauges, which measure the weight of collected rainwater to calculate the height of rainfall. U.S. Pat. No. 7,540,186 to Jeong et al and U.S. Pat. No. 9,588,253 to Li et al are examples of such patents. The accuracy of these rain gauges is usually influenced by temperature fluctuations. Besides, a siphoning system is used in some of these rain gauges to drain away the rainwater when the container of the rain gauge is filled up with rainwater. Consequently, the height of rainfall during the siphoning time is calculated according to the rate of rainfall before the siphoning time. In other words, in such rain gauges, it is assumed that the rate of rainfall during the siphoning time is equal to the rate of rainfall before the siphoning time. Obviously, such an assumption can't be valid for the cases where the intensity of rainfall changes rapidly because of wind.

A few patents describe acoustic disdrometers, which receive the sound signals generated by the impacts of falling raindrops on the receiver of the disdrometer, and process the sound signals to measure the sizes of the raindrops and the intensity of rainfall. U.S. Pat. No. 9,841,533 B2 is an example of an acoustic disdrometer. Acoustic disdrometers are not accurate when the rainfall intensity is high. For example, if some raindrops simultaneously impact the receiver of an acoustic disdrometer, the disdrometer may fail to accurately measure the sizes of the raindrops and the rainfall intensity. Another disadvantage of the acoustic disdrometers is that they are not accurate when the raindrops are pushed by wind.

U.S. Pat. No. 7,584,656 to Senghaas et al discloses a nice rain gauge which uses a plurality of conductivity sensors to determine rain levels. The electronic rain gauge explained in this patent comprises a digital circuit to measure the rainwater level through the conductivity sensors and a solenoid valve to drain away the rainwater inside the measuring tube. A disadvantage of this rain gauge is that after that the rainwater inside the measuring tube of the rain gauge is drained away, the conductivity sensors will remain wet for a few minutes and as a result the rain gauge will suffer from a considerable error until all conductivity sensors get dry. The other disadvantage of the rain gauge is that during the time when the rainwater is drained away, the rainfall will be calculated based on the average rainfall rate. This method will fail in cases where the rainfall rate changes rapidly due to wind.

Considering the disadvantages of the abovementioned patented rain gauges, there is a need for an accurate and robust rain gauge with an electrical output signal which does not require excessive maintenance and is not influenced by weather conditions such as temperature or wind or by external causes such as dust, dew, leaf, feather, snowflakes, and hailstones.

### OBJECTS OF THE INVENTION

The primary object of this invention is to provide an automatic rainfall measurement system in order to measure rainfall with a high accuracy.

Another object of this invention is to provide an automatic rainfall measurement system whose accuracy is not affected by ambient conditions such as temperature or humidity.

A further object of this invention is to provide an automatic rainfall measurement system whose accuracy is not influenced by external objects such as dust, dew, leaf, feather etc.

Another object of this invention is to provide an automatic rainfall measurement system which recognizes raindrops from snowflakes and hailstones and does not collect snow or hail.

A further object of this invention is to provide an automatic rainfall measurement system whose accuracy is not affected by the size or speed of raindrops or by rain intensity.

Another object of this invention is to provide an automatic rainfall measurement system which automatically drains away the rainwater inside the container of the rain gauge.

A further object of this invention is to provide an automatic rainfall measurement system which can be linked to other electronic devices or systems such as automatic irrigation systems or remote weather monitoring systems.

Another object of this invention is to provide an automatic rainfall measurement system with the abovementioned capabilities which is simple and economical at the same time.

A further object of this invention is to provide an automatic rainfall measurement system which is durable and can operate with a high accuracy for a long time.

### SUMMARY OF THE INVENTION

Disclosed is an automatic rainfall measurement system with a set of DC control circuitry which is able to measure the height of rainwater or any other conductive liquid with a high accuracy. The present invention comprises a container with a plurality of conductors and electrodes, a rain collector, a set of DC control circuitry, a rain detector, an electromechanical system to rotate the container of the rain gauge, and a base. The conductors are attached to the wall of the container in columns so that the height of each conductor from the next lower conductor is equal to a constant predetermined value. All conductors are connected to a summing amplifier. The electrodes are attached to the wall of the container in such a way that all electrodes are positioned at equal distances from their adjacent columns of conductors. All electrodes are connected to a DC electric power source. When a volume of rainwater is collected inside the container, the conductors which are touched by rainwater receive equal voltages from the electrodes through rainwater. The voltages received by the conductors are added to one another by the summing amplifier. In order to avoid generating high voltages, which can't be measured by microprocessors, the resulting amount is multiplied by a fraction. At the same time the voltage received by the lowest conductor is measured by a microprocessor. Since all columns of conductors are positioned at equal distances from their adjacent electrodes, the voltages received by all conductors will be equal. Hence the voltage received by the lowest conductor is equal to the voltages received by other conductors. Since the output voltage of the summing amplifier is a negative value, an inverting amplifier is used to convert the output voltage of the summing amplifier to its equivalent positive value. The microprocessor divides the output voltage of the inverting amplifier by the voltage measured from the lowest conductor and multiplies the result by the inverse of the previously mentioned fraction. The result will be equal to the number of conductors which are touched by the rainwater, and since the offset of each conductor from the next lower conductor is equal to a constant predetermined value, the microprocessor can easily calculate the height of rainwater through multiplying the number of the conductors which are in touch with rainwater by the constant offset between two successive conductors.

The rain gauge is initially positioned in such a way that the collector of the rain gauge is inclined toward the ground. Consequently, external objects such as dust, leaf, feather, etc won't enter the container of the rain gauge and won't block the opening of the collector. Thus, filters, which are used to prevent external objects from entering the container of rain gauges, are not needed for the present invention. The rain detector of the system has been designed in such a way that it is not responsive to snowflakes or hailstones. Consequently, the system won't be activated when the rain detector is subjected to snowflakes or hailstones. When it starts raining, the rain detector sends an electrical signal to the control circuitry of the rain gauge. Then the control circuitry activates the electromechanical system in order to rotate the rain gauge to its vertical position. Hence, the rain gauge will be able to collect raindrops and measure the height of rainwater at the same time. If the height of the rainwater inside the container does not increase for a certain period of time, it means that it has stopped raining. In this case, the rain gauge measures the final height of rainwater, and the microprocessor inversely activates the electromechanical system to rotate the container of the rain gauge back to its initial downward facing position with its collector toward the ground. Hence, the rainwater inside the container of the rain gauge is drained away by the gravity force.

In the present invention, the electronic circuitry which measures rainfall does not depend on the electromechanical system, which rotates the container of the rain gauge. As a result, mechanical malfunctions caused by temperature fluctuations, fatigue or the presence of dust on the pivots or joints will not affect the accuracy of the rain gauge. Besides, since external objects such as dust, leaf, feather, etc can neither enter the container of the rain gauge nor block the opening of the collector of the rain gauge, the accuracy of the rain gauge is not influenced by external objects. Since the electronic measurement system of the present invention directly measures the height of rainwater, its accuracy is not affected by the size or speed of raindrops or intensity of rain or density of rainwater. The DC control circuitry of the present invention, which will be explained in details, is much simpler than the control circuitry of similar rain gauges. Finally, since the rain detector of the system is not responsive to snowflakes or hailstones, the container of the rain gauge of the system won't collect snow or hail.

### BRIEF DESCRIPTION OF THE DRAWINGS

FIG. 1 illustrates a perspective view of the first embodiment of the rainfall measurement system wherein the system is ready to collect raindrops and measure rainfall.

FIG. 2 illustrates a perspective view of the first embodiment of the rainfall measurement system wherein the system is in its standby mode.

FIG. 3 illustrates a perspective view of the rain gauge of the first embodiment of the system.

FIG. 4 illustrates a perspective exploded view of the rain gauge of the first embodiment of the system.

FIG. 5 illustrates a perspective view of the container of the rain gauge of the first embodiment of the system.

FIG. 6 illustrates the front view of the placement pattern of the electrodes and conductors of the rain gauges of the first and second embodiment of the system.

FIG. 7 illustrates the front view of a possible pattern for the placement of the conductors of the rain gauges of the first and second embodiments of the system.

FIG. 8 illustrates a perspective view of the collector of the rain gauge of the first embodiment of the system.

FIG. 9 illustrates a perspective view of the motor housing of the first embodiment of the system.

FIG. 10 illustrates a perspective exploded view of the motor housing of the first embodiment of the system.

FIG. 11 illustrates a perspective view of the rain detector of the first and second embodiments of the system.

FIG. 12 illustrates a perspective exploded view of the rain detector of the first and second embodiments of the system.

FIG. 13 illustrates the front view of a rain sensor of the rain detector of the first and second embodiments of the system.

FIG. 14 illustrates the block diagram of the control circuitry of the first embodiment of the system.

FIG. 15 illustrates the summing amplifier and the inverting amplifier of the control circuitry of the first and second embodiments of the system.

FIG. 16 illustrates the first part of the flowchart of a possible algorithm which can be executed by the microprocessor of the control circuitry to run the first embodiment of the system.

FIG. 17 illustrates the second part of the flowchart of a possible algorithm which can be executed by the microprocessor of the control circuitry to run the first embodiment of the system.

FIG. 18 illustrates a perspective view of the second embodiment of the rainfall measurement system wherein the system is in standby mode.

FIG. 19 illustrates a perspective view of the second embodiment of the rainfall measurement system wherein the first rain gauge is ready to collect raindrops and measure rainfall.

FIG. 20 illustrates a perspective view of the second embodiment of the rainfall measurement system wherein the second rain gauge is ready to collect rain drops and measure rainfall.

FIG. 21 illustrates a perspective view of the collector of the rain gauges of the second embodiment of the system.

FIG. 22 illustrates a perspective view of the motor housing of the second embodiment of the system.

FIG. 23 illustrates a perspective exploded view of the motor housing of the second embodiment of the system.

FIG. 24 illustrates another perspective exploded view of the motor housing of the second embodiment of the system.

FIG. 25 illustrates the block diagram of the control circuitry of the second embodiment of the system.

FIG. 26 illustrates the first part of the flowchart of a possible algorithm which can be executed by the microprocessor of the control circuitry to run the second embodiment of the system.

FIG. 27 illustrates the second part of the flowchart of a possible algorithm which can be executed by the microprocessor of the control circuitry to run the second embodiment of the system.

### DETAILED DESCRIPTION OF THE INVENTION

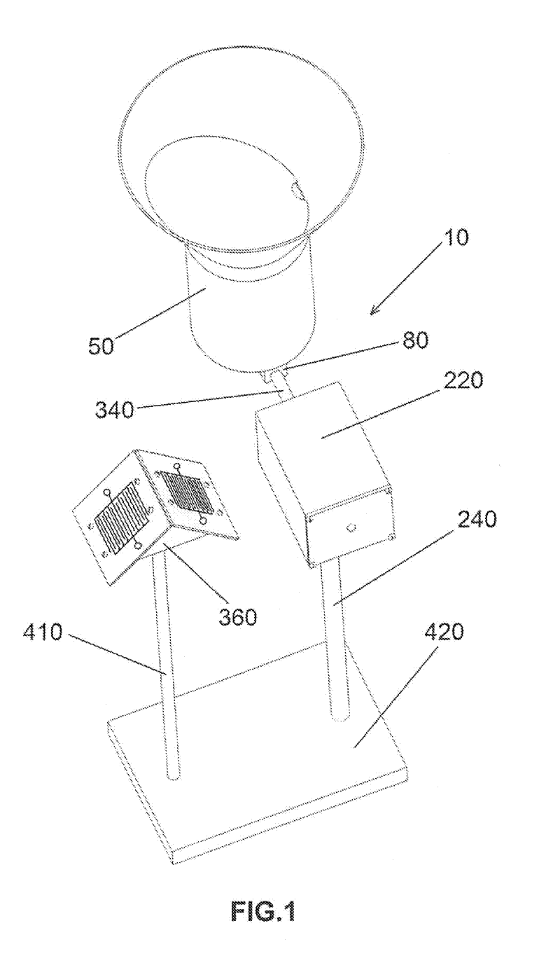

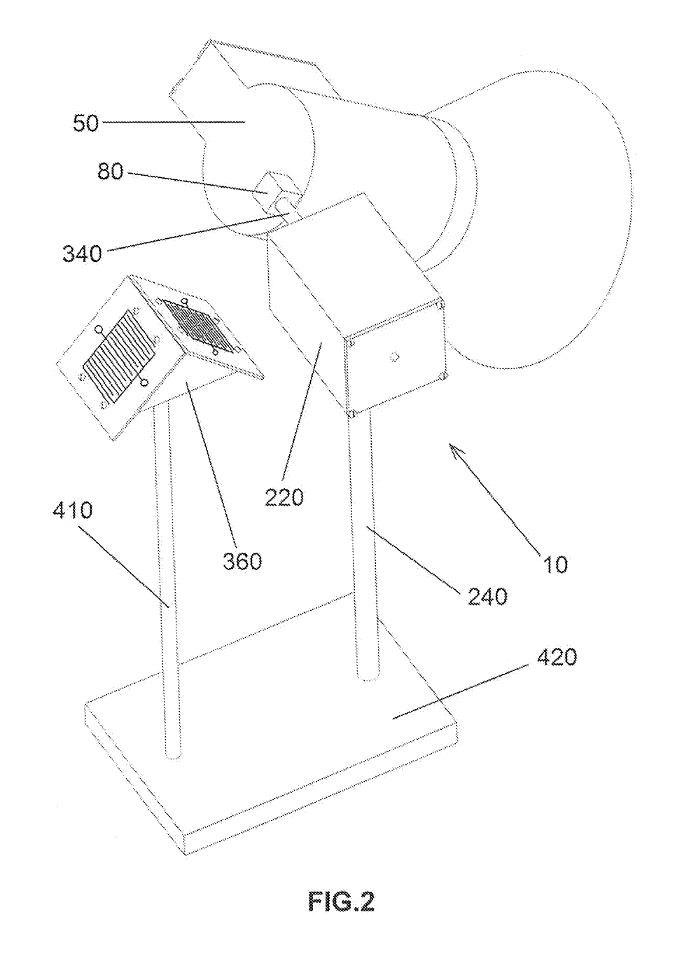

The first embodiment of the present invention 10, which has been illustrated in FIG. 1 and FIG. 2, comprises a rain gauge 50, a rain detector 360 a base 420, and a motor housing 220, which includes an electric motor 310 with a gearbox 330, an encoder 320, and part of the control circuitry 430. The rain gauge 50 of the first embodiment of the system 10, which will be described in details, is attached to the motor shaft 340 through a shaft mount 80, which is fixed to the bottom 140 of the rain gauge 50. The motor housing 220 and the rain detector 360 can be permanently or temporarily fixed to the base 420 through support rods 240 and 410. That is, the support rods 240 and 410 may be screwed or welded to the base 420 or they may be a permanent part of the base 420.

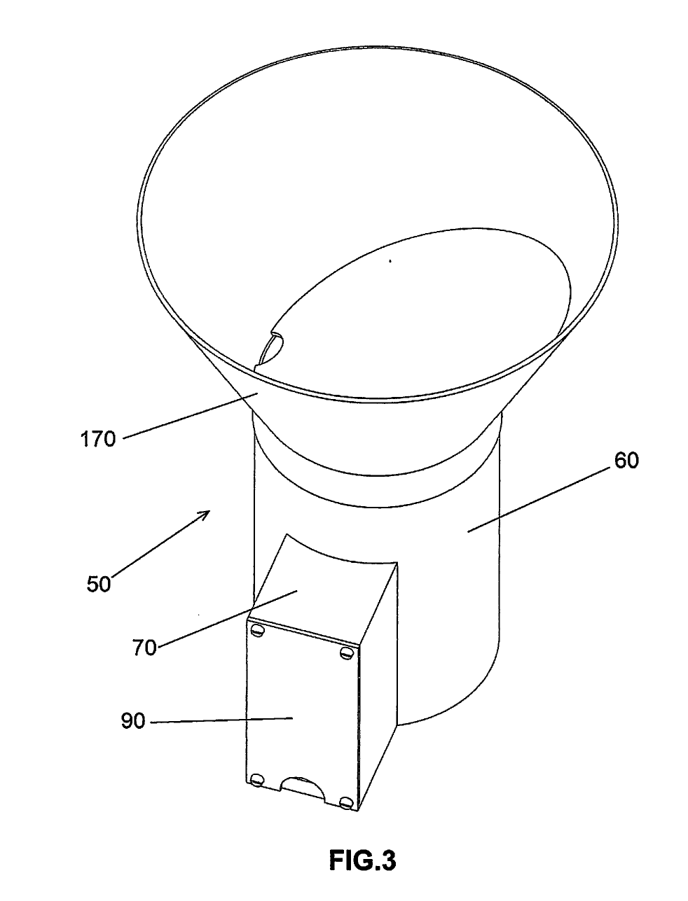

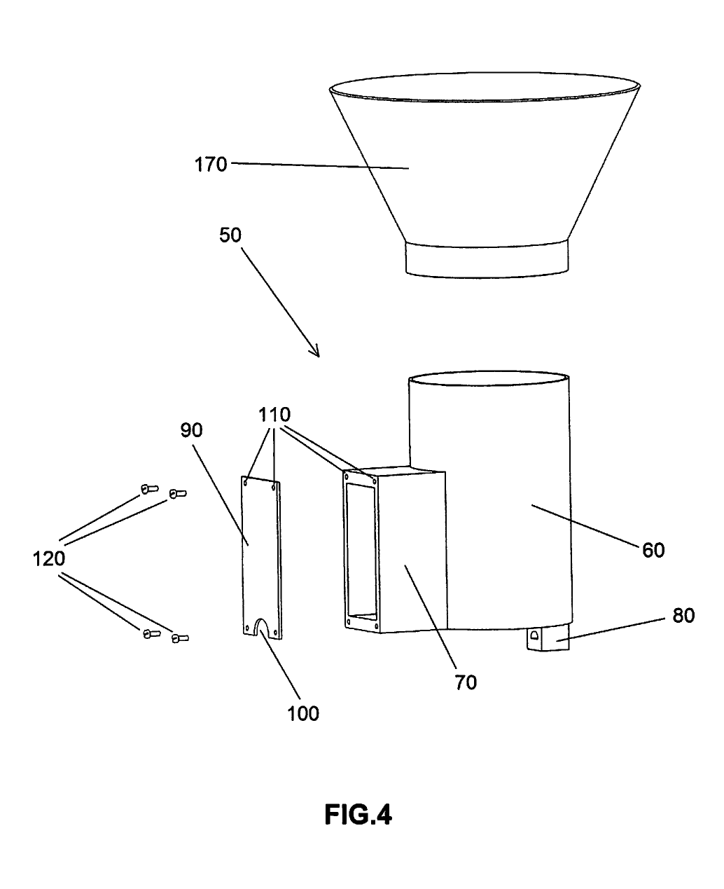

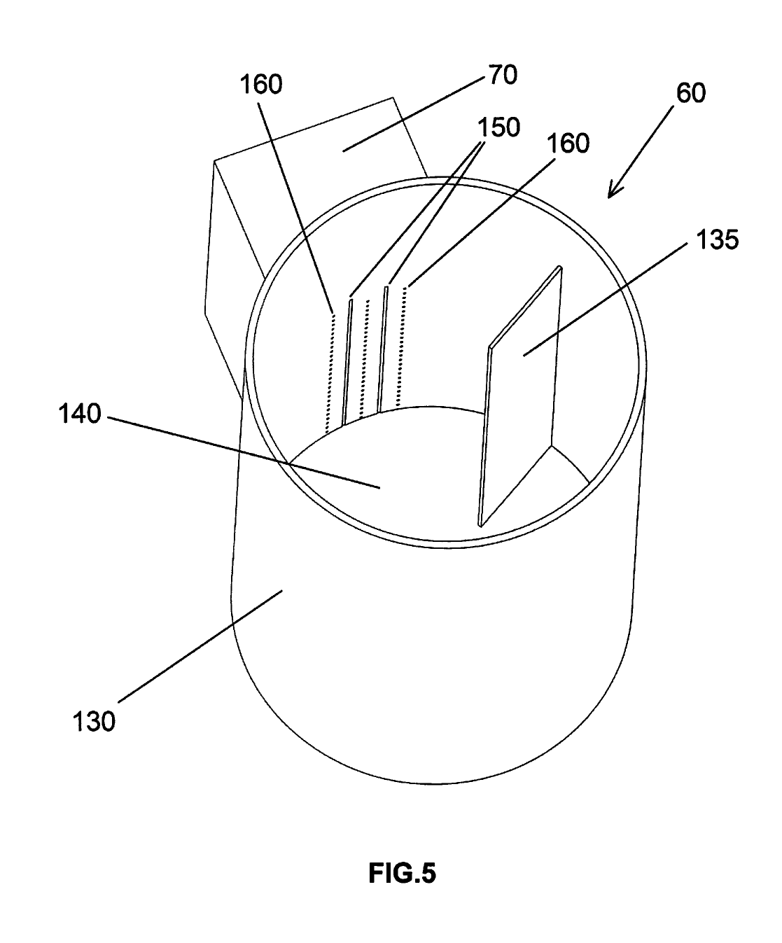

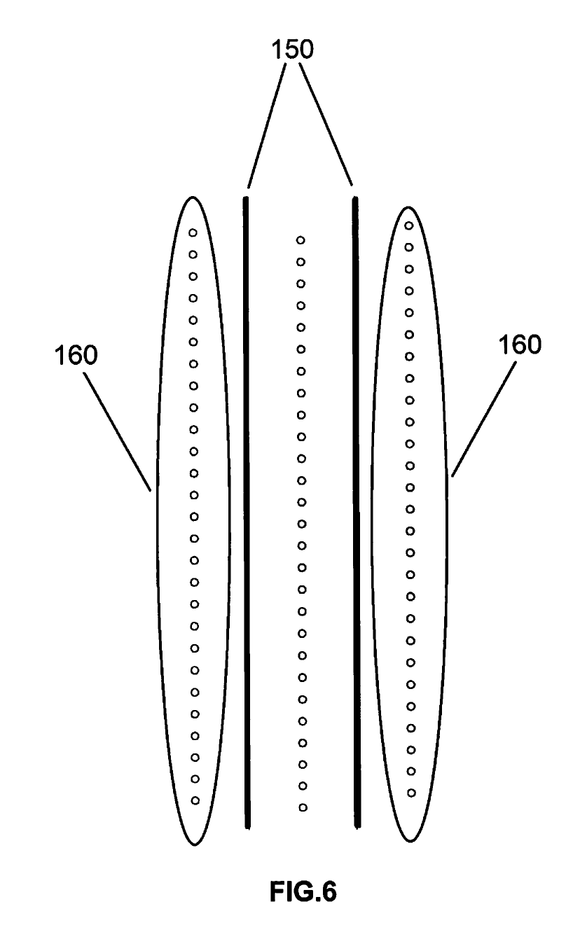

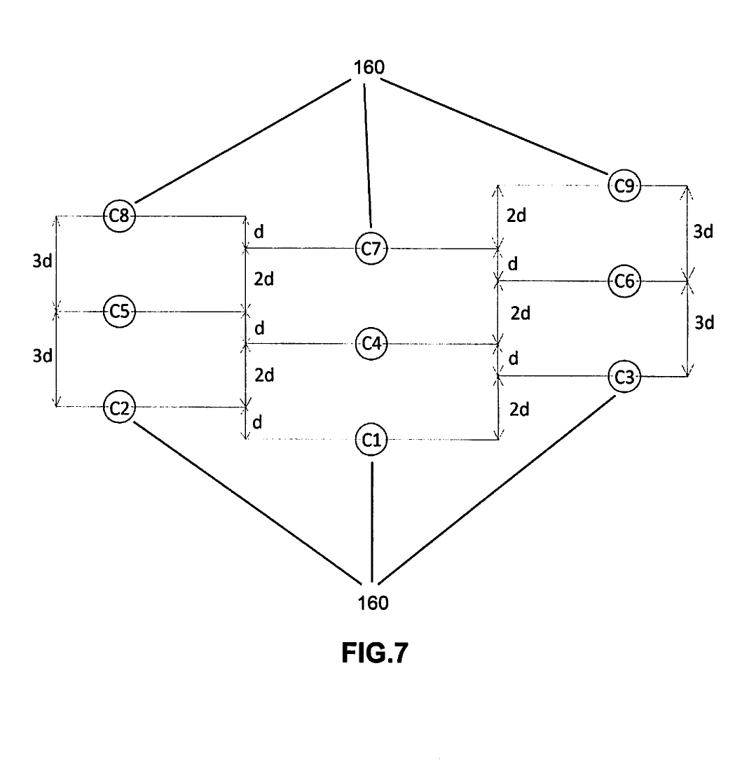

The rain gauge 50 of the first embodiment of the system 10, which has been shown in FIG. 3 and FIG. 4, comprises a container 60 with a shaft mount 80, a collector 170, and a circuit housing 70 with a lid 90. The circuit housing 70 includes part of the electronic circuitry 430 of the first embodiment of the system 10. The shaft mount 80 and the circuit housing 70 may be attached to the container 60 or may be a permanent part of the container 60. The lid 90 of the circuit housing 70 can be attached to the circuit housing 70 through screws 120 and screw holes 110 or by other means and methods. An opening 100 has been provided on the lid 90 so that the wires which connect the circuit of the rain gauge 50 to the other parts of the control circuitry 430 can pass through the opening 100. The collector 170 is preferred to be attached to the container 60 temporarily so that it can be removed for the purpose of diagnosis. The container 60 of the rain gauge 50 shown in FIG. 3, FIG. 4, and FIG. 5 is cylindrical with a side wall 130 and a bottom 140, but it may be in any other suitable shape such as cubic. The container 60, circuit housing 70, and the shaft mount 80 are preferred to be made of hard plastic to be as light as possible, but they can be made of any other suitable nonconductive material. FIG. 5 illustrates the inside of the container 60 of the rain gauge 50. A plurality of electrodes 150 together with a plurality of conductors 160 are attached to the side wall 130 of the container 60. A thin shield 135 is placed between the area where raindrops fall and the electrodes 150 and conductors 160 to prevent falling raindrops from bouncing on the conductors 160. The shield 135 can be a permanent part of the container 60 and should be as thin as possible so that it does not occupy a considerable volume of the container 60. Note that for highly accurate measurement of rainfall, the base area of the empty cylindrical space of the container 60 should be considered as the area of the bottom 140 of the container 60 minus the common area between the shield 135 and the bottom 140. FIG. 6 shows a front view of the electrodes 150 and conductors 160, which are attached to the side wall 130 of the container 60. Although FIG. 6 illustrates two electrodes 150 and three columns of conductors 160, more electrodes 150 and columns of conductors 160 may be used if necessary. In the shown pattern, each electrode 150 lies between two columns of conductors 160 so that the columns of conductors 160 are at equal distances from their neighboring electrodes 150. This is important because rainwater has some electrical resistivity. Consequently, there will be some voltage drop due to the resistivity of rainwater. That is why, the columns of conductors 160 should be at equal distances from their neighboring electrodes 150 so that all conductors 160 receive the same voltage. FIG. 7, which is a front view of a few of the conductors 160, shows a possible placement pattern of the conductors 160 in three columns. The two electrodes 150 which should lie between the columns of conductors 160 have not been shown in FIG. 7 to avoid making the figure messy. As it is observed from FIG. 7, each conductor 160 has some predetermined offset from its neighboring conductors 160. In this three-column pattern, each conductor 160 has an offset of 3d from its neighboring conductor 160 in the same column. Where d is a predetermined constant value. Besides, in the three-column pattern illustrated in FIG. 7, each conductor 160 has an offset of d from its immediate upper conductor 160 in the left column and an offset of 2d from its immediate upper conductor 160 in the right column. Consequently, in the shown pattern, as the rainwater level rises, the rainwater touches conductors C1 to C9 successively. Although, it is possible to locate all conductors 160 in a single column, it is recommended to use patterns with as many columns of conductors as possible to increase the distance between two neighboring conductors 160 in each column so that when the rainwater inside the container 60 is drained away, rainwater drops are not stuck between the conductors 160. Besides, the more columns of conductors 160 are, the more the number of conductors 160 can be. As a result, the predetermined offset d can be chosen to be as small as possible, and consequently the accuracy of the rain gauge can be increased. It should be mentioned that the electrodes 150 and the conductors 160 should be placed into the side wall 130 of the container 60 in such a way that they do not occupy a considerable volume of the container 60, which is used for collecting rainwater, otherwise there will be some error in the measurement of rainwater height due to the volume occupied by electrodes 150 and conductors 160. However, if the electrodes 150 and conductors 160 are small in size, the mentioned error will be small. The electrodes 150 and conductors 160 may be made of any conductive material such as various metals, but it is recommended to make them of carbon rods. The reason behind this recommendation is that, since the circuit 430 of the rain gauge 50 is a DC circuit, the electrodes 150 and conductors 160 which are made of any sort of metal, will be corroded very fast due to electrolysis. Another noteworthy issue is that the offset d, which is shown in FIG. 7, is a crucial parameter for the accuracy of the rain gauge 50. In fact, assuming that the manufacturing error of the various components of the rain gauge 50 and the error of the control circuitry 430 are equal to zero, the maximum error of the rain gauge 50 will be equal to d(D₁/D₂)². Where, d is the offset shown in FIG. 7, D₁ is the diameter of the base area of the empty space of the container 60, and O₂ is the upper diameter of the collector 170. The method to calculate the maximum error of the rain gauge 50 will be explained in details in the following paragraph.

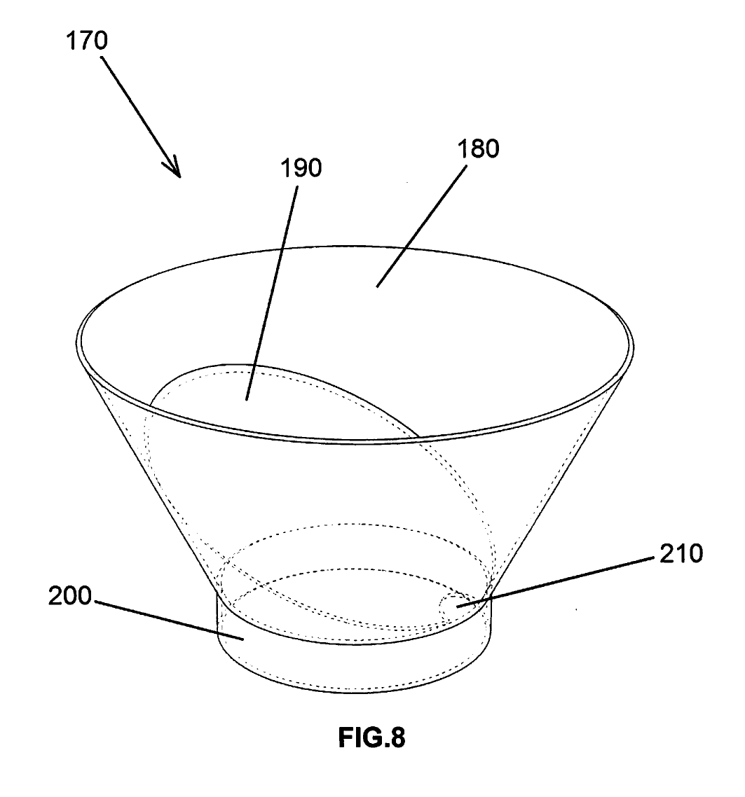

The collector 170 of the rain gauge 50 is illustrated in FIG. 8. The collector 170 shown in FIG. 8 is a funnel-like water catchment 180 with an inclined bottom 190 and a tube 200. There is an opening 210 at the lowest part of the inclined bottom 190 through which rainwater flows into the container 60 of the rain gauge 50. In fact, the inclined bottom 190 of the collector 170 prevents raindrops from falling on the conductors 160 and directs them toward the opening 210, which lies at a position away from the conductors 160. The diameter of the tube 200 is slightly greater than the diameter of the container 60 so that when the mouth of the container 60 is pushed into the tube 200 of the collector 170, the collector 170 tightly attaches to the container 60. The collector 170 is preferred to be made of hard plastic to be light and corrosion-resistant, but it can be made of other suitable materials. The upper diameter of the collector 170 plays a key role in adjusting the accuracy of the rain gauge 50. The maximum error of the rain gauge 50 can be calculated as follows: Let D₁ be the diameter of the base area of the empty space of the container 60. Note that the base area of the empty space of the container 60 is equal to the bottom area of the container 60 minus the common area between the shield 135 and the bottom 140. In other words, assuming that D is the internal diameter of the container 60 and A is the cross-sectional area of the shield 135, then the diameter of the base area of the empty space of the container 60 is calculated as follows:

pi(D₁/2)²=pi(D/2)²−A, which results in, D₁=2[(D₂/2)²−A/pi]^{0.5}. Where pi=3.14159.

Let D₂ be the upper diameter of the collector 170, and h be the height of the rainwater inside the container. As it is observed from FIG. 7, if the level of rainwater lies somewhere between k'th conductor and (k+1)'th conductor, then the measured height of the rainwater inside the container 60 will be either hₘ=kd or hₘ=(k+1)d. In other words, the maximum measurement error in the height of the rainwater inside the container 60 of the rain gauge 50 will be equal to d. Thus, the maximum error of the measured volume of rainwater will be pi(D₁/2)²d. This volume of water, in an imaginary cylindrical container with the same diameter as the upper diameter of the collector 170, will be equal to pi(D₂/2)²Hₑ. Where, Hₑ is the height of the rainwater inside the imaginary cylindrical container. Thus, pi(D₁/2)²d=pi(D₂/2)²Hₑ, which results in Hₑ=d(D₁/D₂)². Therefore, the maximum error of the rain gauge 50 will be equal to d(D₁/D₂)².

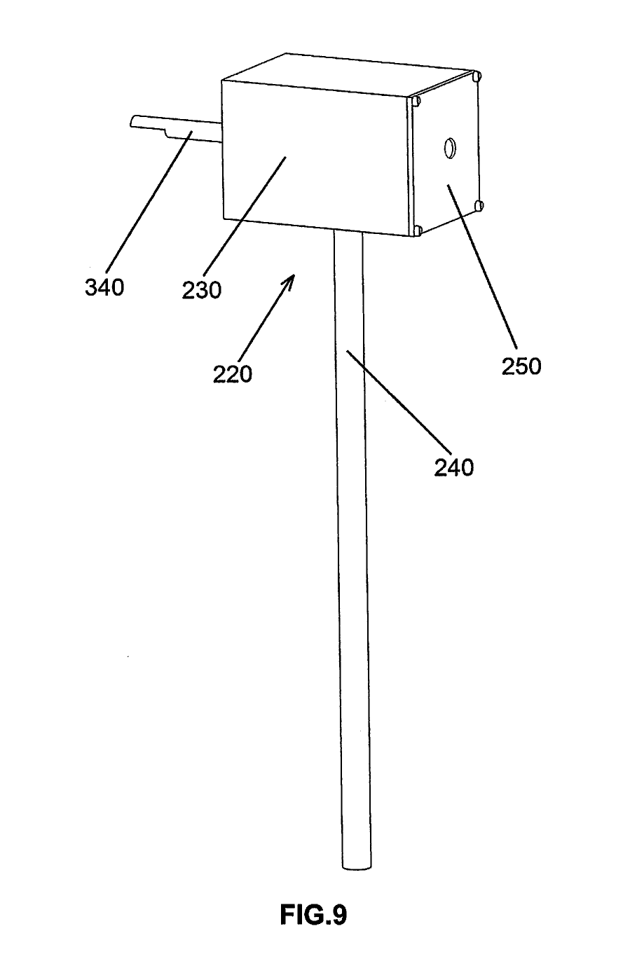

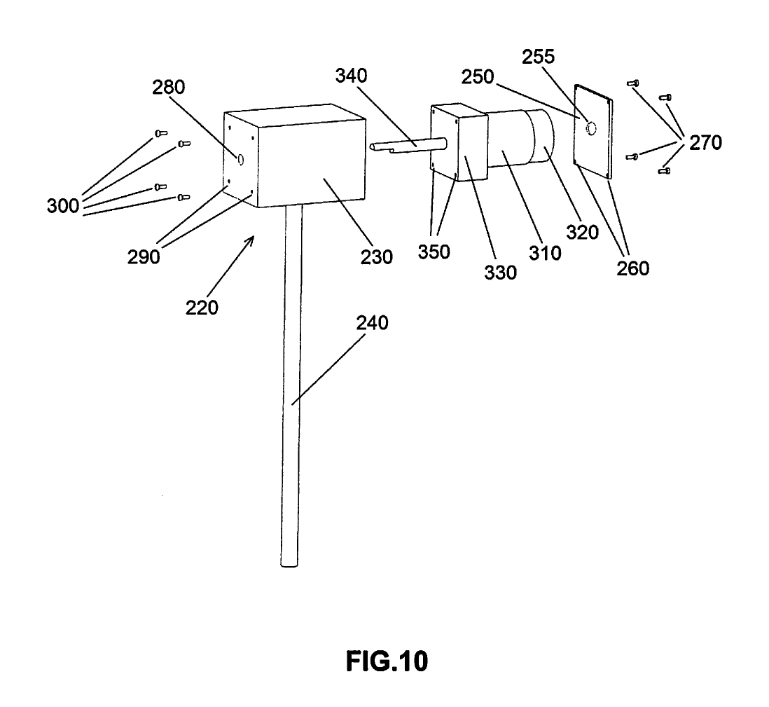

The motor housing 220 illustrated in FIG. 9 and FIG. 10 comprises a box 230, a support rod 240, and a lid 250. The box 230 of the motor housing 220 includes part of the electronic circuitry 430, which is not shown in FIG. 9 and FIG. 10, an electric motor 310 with a gearbox 330, a shaft 340, and an encoder 320. The box 230 of the motor housing 220 shown in FIG. 10 has been designed to protect its contents from rain and other possible damaging causes. However, the motor housing 220 may be in other suitable shapes such as cylindrical. The electric motor 310 can be attached to the box 230 of the motor housing 220 through a plurality of screws 300 and screw holes 290 and 350 or by other suitable fasteners and methods. A shaft hole 280 on the front face of the box 230 allows the shaft 340 of the electric motor 310 to come out of the box 230 so that it can be fastened to the shaft mount 80 of the rain gauge 50. The lid 250 of the motor housing 220 can be attached to the box 230 through a plurality of screws 270 and screw holes 260 or other fasteners or methods. An opening 255 has been provided on the lid 250 so that wires which connect the circuit inside the motor housing 220 to the rain sensors 370 and to the circuit of the rain gauge 50 can pass through the opening 255. The support rod 240 of the motor housing 220 may be screwed into the box 230 or it can be fixed to the box 230 by other fasteners and methods. The motor housing 220 can be made of aluminum to be light and corrosion-resistant. However, it can be made of other proper materials such as hard plastic.

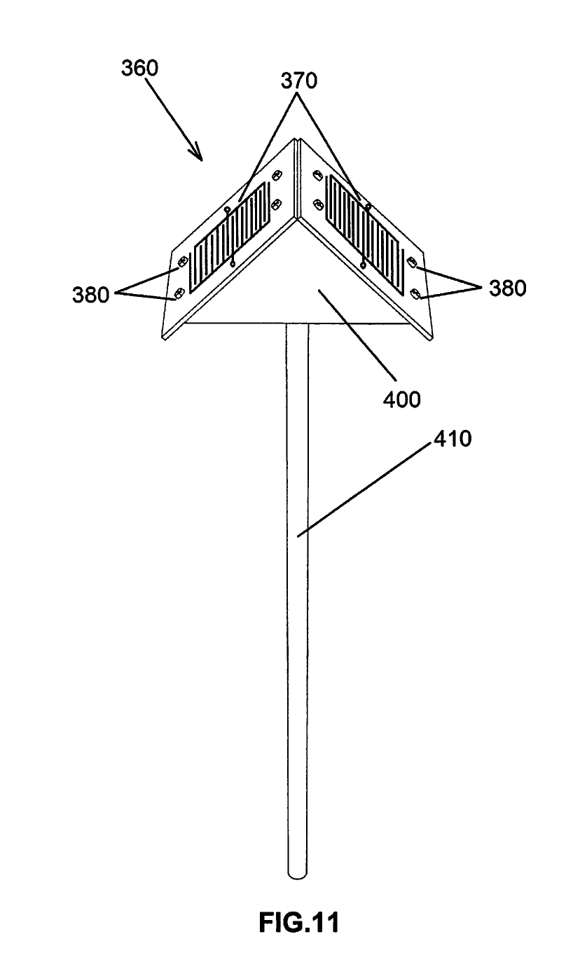

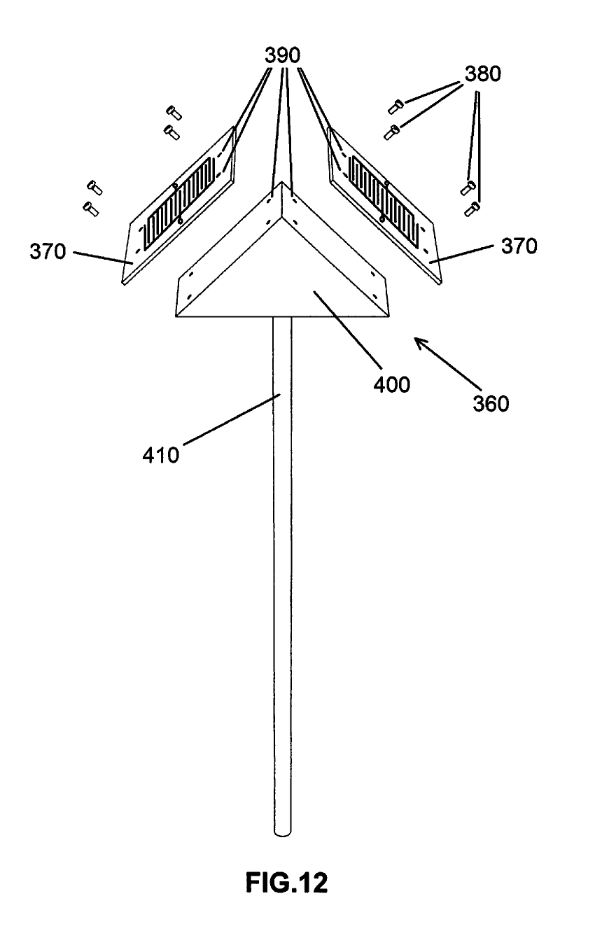

The rain detector 360, which has been illustrated in FIG. 11 and FIG. 12, includes two rain sensors 370, a sensor support 400, and a support rod 410. The rain sensors 370 can be attached to the sensor support 400 through a plurality of screws 380 and screw holes 390 or by other fasteners and methods. The sensor support 400 shown in FIG. 11 and FIG. 12 is a triangular prism, but it may be in any other suitable shape such as pyramid, conical, etc. The side surfaces of the sensor support 400 should have a slope of at least 45 degrees so that the raindrops which fall on the rain sensors 370 do not remain on the rain sensors 370 and roll off downward. The support rod 410 of the rain detector 360 can be screwed into the sensor support 400 or can be fixed to the sensor support 400 by other fasteners or methods. The sensor support 400 and the support rod 410 can be made of aluminum or any other suitable material which is light and corrosion-resistant such as hard plastic. It should be mentioned that the rain detector 360 described here may be replaced by other sorts of rain detectors, which have been invented so far or will be invented in future.

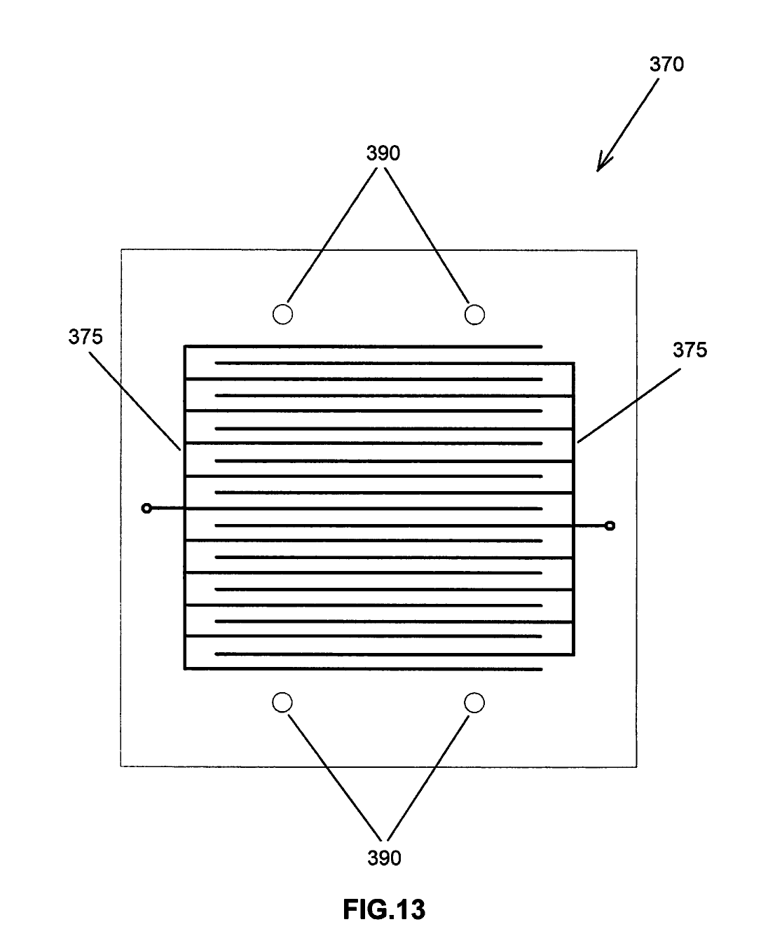

The rain sensor 370, which has been illustrated in FIG. 13, is simply a printed circuit 375 with no electrical components. The horizontal tracks of the circuit are parallel to one another, and each horizontal track is separated from its neighboring horizontal track by a small distance of about 1 mm to 2 mm. In each pair of neighboring parallel tracks, one track is connected to the input terminal of the circuit 375 through a vertical track, and the other one is connected to the output terminal through another vertical track. Hence, when a raindrop falls on the circuit 375 of the rain sensor 370, the pair of neighboring parallel tracks which have been subjected to the raindrop are connected to each other by the raindrop and thus, electric current flows from the input terminal to the output terminal of the circuit 375 of the rain sensor 370. Finally, the current flow is transferred to a microprocessor as an electrical signal. Note that when the rain sensor 370 is subjected to snowflakes or hailstones, no signal will be sent by the rain sensor 370 simply because of very low conductivity of snowflakes and hailstones.

The base 420 of the first embodiment of the system 10 has been chosen to be a rectangular plate with a certain thickness. However, it may be in any other suitable shape such as a circular or elliptic disc. The base 420 can be made of aluminum to be corrosion-resistant and light or it can be made of any other suitable material such as hard plastic.

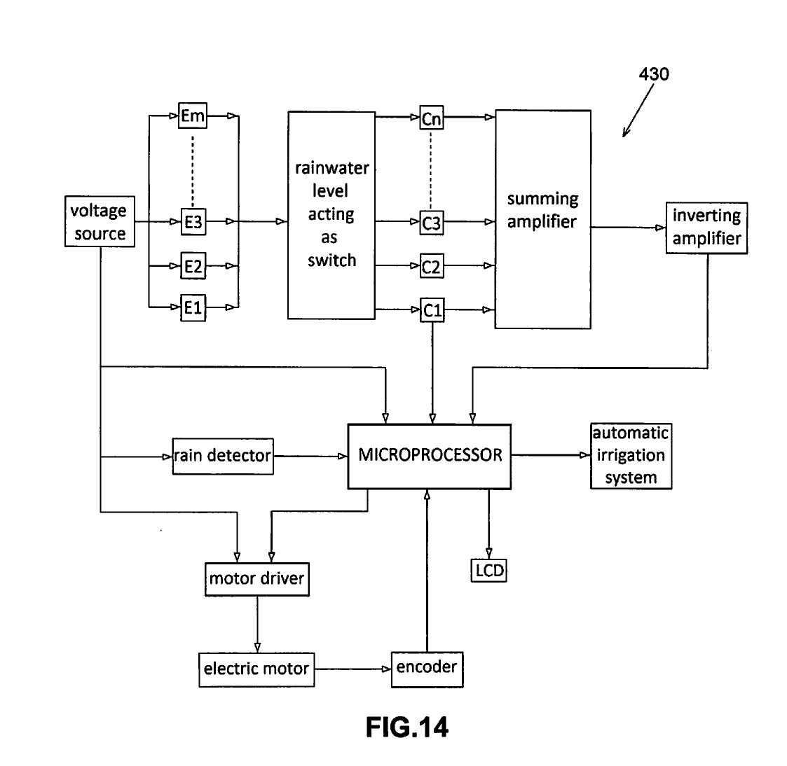

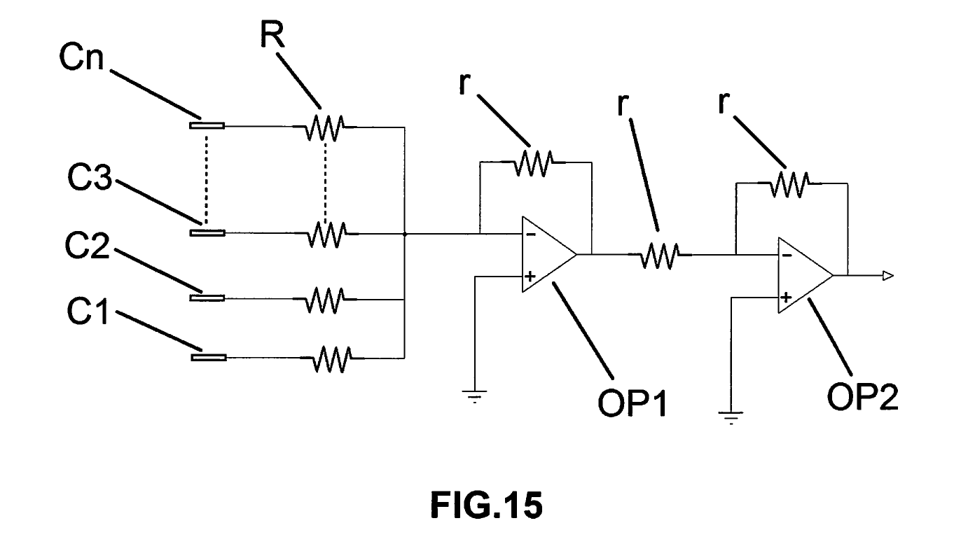

The control circuitry 430 of the first embodiment of the system 10 has been illustrated in FIG. 14. The control circuitry 430 of the first embodiment of the system 10 comprises a DC voltage source, a plurality of electrodes 150 designated by E1 to Em, rainwater, a plurality of conductors 160 designated by C1 to Cn, a summing amplifier, an inverting amplifier, a rain detector 360, a microprocessor, a motor driver, an electric motor 310, an encoder 320, and an LCD. As it is observed from FIG. 14, the electrodes E1 to Em are connected to the voltage source of the circuitry 430. As the level of rainwater rises inside the container 60 of the rain gauge 50, the rainwater successively connects the conductors C1 to Cn to the electrodes E1 to Em. Consequently, among the conductors C1 to Cn those which are touched by rainwater receive equal voltages from the electrodes E1 to Em and transfer the voltages to the summing amplifier through wires as shown in FIG. 15. The summing amplifier shown in FIG. 15 consists of a plurality of input resistors R with equal resistances, an OPAMP OP1, and a feedback resistor r. The output voltage of the summing amplifier is received by an inverting amplifier, which has been shown in FIG. 15. The inverting amplifier includes an input resistor r, a feedback resistor r, and an OPAMP OP2. Assume that V_{SU} is the output voltage of the summing amplifier, V_{C} is the voltage of the lowest conductor C1, V_{I} is the output voltage of the inverting amplifier, k is the number of the conductors C1 to Ck touched by the rainwater, d is the offset between two successive conductors Ci and C(i+1), R is the resistance of the input resistors of the summing amplifier, r is the feedback resistance of the summing amplifier, h is the height of the rainwater inside the container 60, H is rainfall, which is measured in depth, D1 is the diameter of the base area of the empty space of the container 60, and D2 is the upper diameter of the collector 170. The output voltage of the summing amplifier is determined from V_{SU}=−k(r/R)V_{C}. In order to avoid generating high voltages, which cannot be measured by microprocessors, the magnitudes of r and R should be chosen in such a way that V_{SU} does not exceed 5 volts. For example if there are 200 conductors 160 in the rain gauge 50, and V_{C}=10 volts, then r/R can be chosen to be equal to 1/400. Thus the maximum output voltage of the summing amplifier will be −5 volts. Since the resistance of the input resistor r of the inverting amplifier is equal to the resistance of its feedback resistor r, the gain of the inverting amplifier is equal to unity. Hence the output voltage of the inverting amplifier can be determined from V_{I}=−V_{SU}=k(r/R)V_{C}. As it is observed from FIG. 14, the microprocessor receives the output voltage of the inverting amplifier, V_{I}, and the voltage of the lowest conductor C1, V_{C}, which is equal to the voltage of the conductors C1 to Ck, which are in touch with rainwater. Then the microprocessor makes the following calculations: k=(RV₁)/(rV_{C}), h=dk, and H=(D₂/D₁)²h.

Thus, the microprocessor determines rainfall, H. It should be mentioned that the wires which connect the electrodes 150 and the conductors 160 to the summing amplifier together with the summing and inverting amplifiers lie inside the circuit housing 70 while, the voltage source, the microprocessor, the motor driver, the electric motor 310, and the encoder 320 lie inside the box 230 of the motor housing 220. The operation of the control circuitry 430 is explained in details in the next paragraph.

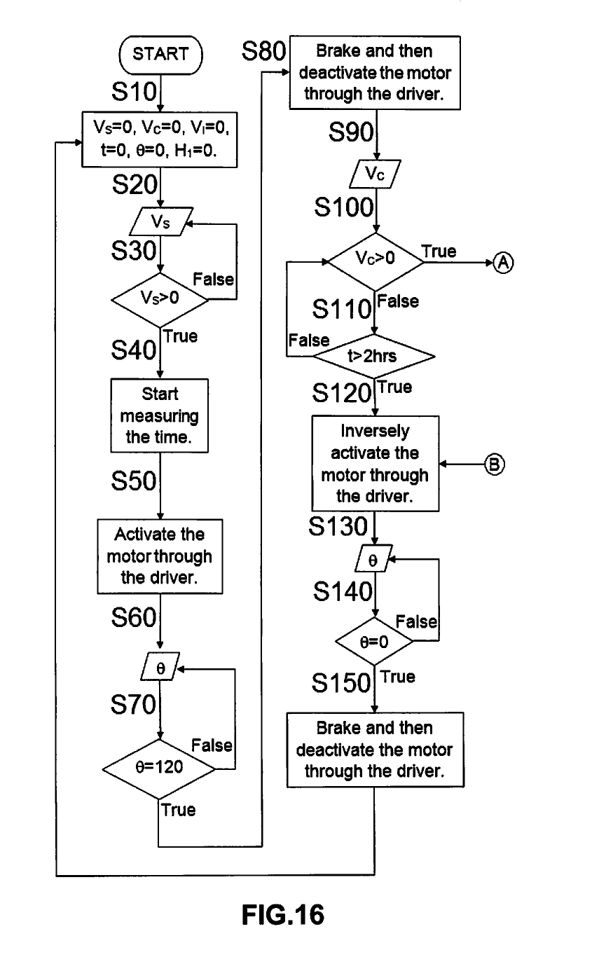

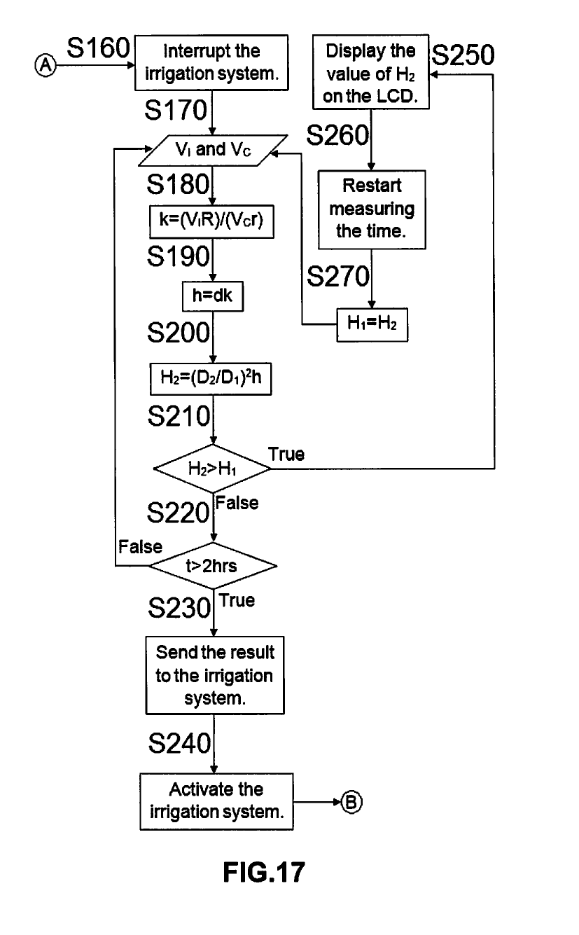

FIG. 16 and FIG. 17 illustrate an algorithm which can be used by the microprocessor to run the first embodiment of the system 10. When it starts raining, using this algorithm, the microprocessor communicates with the motor driver and the encoder 320 to vertically position the rain gauge 50, interrupts an automatic irrigation system, which is connected to the first embodiment of the system 10, measures rainfall by the previously mentioned method, and displays rainfall, which has been measured in depth, on an LCD. After that it stops raining, the microprocessor informs the automatic irrigation system of rainfall, reactivates the automatic irrigation system and returns the rain gauge 50 back to its initial downward facing position. Assume that V_{S} is the voltage received from the rain detector 360 by the microprocessor, t is the measured time, θ is the angular position of the motor shaft 340, H₁ is the rainfall calculated according to the former voltage measurements, and H₂ is the rainfall calculated according to the current voltage measurements. In step S10 of the algorithm, the values of V_{S}, V_{C}, V_{I}, t, θ, and H₁ are set equal to zero. In step S20, the voltage received from the rain detector 360 is measured. In step S30, it is decided if the voltage received from the rain detector 360 is greater than zero or not. If the voltage received from the rain detector 360 is not greater than zero, it means that it is not raining. In this case, the microprocessor keeps measuring the voltage received from the rain detector 360 and comparing its value with zero. But if the voltage received from the rain detector 360 is greater than zero, then the microprocessor goes to step S40 of the algorithm and starts measuring the time. In step S50, the electric motor 310 is activated through the motor driver. As the motor shaft 340 starts rotating, the angular position of the motor shaft 340 is measured through the encoder 320 in step S60. Then in step S70 of the algorithm shown in FIG. 16 and FIG. 17, it is decided if the angular position of the motor shaft 340 is equal to the desired value, which has been chosen to be 120 degrees in this case. In other words, in the algorithm shown in FIG. 16 and FIG. 17, it has been assumed that the rain gauge 50 was initially inclined downward by an angle of 120 degrees from its vertical position. The angular position of the motor shaft 340 is continuously measured by the encoder 320 until it reaches 120 degrees. When the angular position of the motor shaft 340 reaches 120 degrees, the rain gauge 50 will be in its vertical position. In this case the motor driver brakes and stops the motor 310 in Step S80. Then in step S90, the voltage of the lowest conductor C1 is measured. In step S100 the microprocessor decides if the voltage of the lowest conductor C1 is greater than zero or not. If the voltage of the lowest conductor C1 remains equal to zero for a certain period of time, which is two hours in this case, then it means that it is not raining, and the signal sent by the rain detector 360 was the result of an accidental water spill on the rain sensors 370. But if the voltage of the lowest conductor C1 becomes greater than zero within the two hours, then it means that it is raining, and some water has been collected by the container 60 of the rain gauge 50. In step S110, the microprocessor decides if the time during which the voltage of the lowest conductor C1 has remained equal to zero is greater than two hours or not. If the voltage of the lowest conductor C1 remains equal to zero for two hours, the electric motor 310 is inversely activated by the motor driver in step S120. That is, the electric motor 310 starts rotating the rain gauge 50 back to its initial downward facing position shown in FIG. 2. In step S130, the angular position of the motor shaft 340 is measured by the encoder 320 then in step S140, the microprocessor decides if the angular position of the motor shaft 340 is equal to zero or not. If the angular position of the motor shaft 340 is equal to zero, it means that the rain gauge 50 is back to its initial downward facing position. In this case, the motor driver brakes the electric motor 310 and then deactivates it in step S150. Otherwise, the microprocessor keeps the electric motor 310 running until the angular position of the motor shaft 340 becomes equal to zero. After that the rain gauge 50 is back to its initial position, the microprocessor returns to step S10 and restarts applying the algorithm shown in FIG. 16 and FIG. 17. If in step S100 it is decided that the voltage of the lowest conductor C1, which was measured in step S90, is greater than zero, the microprocessor goes to step S160 and interrupts the automatic irrigation system, which is connected to the first embodiment of the system 10. Then the voltage of the lowest conductor C1 is measured once again together with the output voltage of the inverting amplifier in step S170. The point behind the remeasurement of the voltage of the lowest conductor C1 is that the voltage of the lowest conductor C1 may slightly change due to noise or other reasons over time, and since the output voltage of the inverting amplifier is a function of the voltage of the lowest conductor C1, any changes in the voltage of the lowest conductor C1 will lead to variations in the output voltage of the inverting amplifier. In other words, in order to make sure that both the voltage of the lowest conductor C1 and the output voltage of the inverting amplifier are measured under identical conditions and are correlated to each other according to equation V₁=−V_{SU}=k(r/R)V_{C}, they should be measured simultaneously. In step S180, the number of the conductors which are in touch with the rainwater is determined from equation k=(RV_{I})/(rV_{C}). Then the microprocessor determines the height of the rainwater inside the container 60 of the rain gauge 50 from h=dk in step S190. In step S200, the current rainfall is calculated from H₂=(D₂/D₁)²h. Then the current rainfall is compared with the former rainfall in step S210. If the current rainfall, H₂, is not greater than the previous one, H₁, the microprocessor goes to step S220 to decide if the time measured since the last increase in rainfall is greater than a certain period, which is two hours in this case, or not. If the time measured since the last increase in the rainfall is greater than two hours, then it means that it has stopped raining. In this case, the automatic irrigation system is informed of the final rainfall in step S230 and then the automatic irrigation system is activated by the microprocessor in step S240. Then the microprocessor goes to step S120 and starts the previously described process to rotate the rain gauge 50 back to its initial downward facing position. When the rain gauge 50 is back to its initial downward facing position, the rainwater inside the rain gauge 50 is drained away by gravitational force through the opening 210 on the bottom 190 of the collector 170. In step S220, if the time measured since the last increase in rainfall is less than the threshold period of time, which has been chosen to be two hours in this case, the microprocessor goes back to step S170 to update the current rainfall through steps S170 to S200 and then compares the updated value of the current rainfall with the previous one in step S210. In step S210 if the current rainfall, H₂, is greater than the previous one, H₁, it means that it keeps raining. In this case the microprocessor goes to step S250 to display the current rainfall on the LCD. Then it restarts measuring the time in step S260. In step S270 the value of the former rainfall, H₁, is replaced by the value of the current rainfall, H₂. Then microprocessor goes to step S170 to update the current rainfall through steps S170 to S200.

In order to operate the first embodiment of the system 10, the rain gauge 50 should initially lie in its downward facing position as shown in FIG. 2. When the rain gauge 50 is inclined downward, the opening 210 on the bottom 190 of the collector 170 won't be blocked by external objects such as leaf, feather, dust, etc and external objects won't enter the container 60 of the rain gauge 50. As soon as a raindrop falls on a rain sensor 370 of the rain detector 360, the rain detector 360 sends an electrical signal to the microprocessor. Then the microprocessor activates the electric motor 310 and consequently, the electric motor 310 rotates the rain gauge 50 through the gearbox 330 and the shaft 340. Obviously, the gearbox 330 is used in order to reduce the speed of the shaft 340 and to increase its torque. The microprocessor frequently measures the angular position of the shaft 340 through the encoder 320. When the rain gauge 50 reaches its vertical position shown in FIG. 1, the microprocessor brakes the electric motor 310 through the motor driver and then deactivates it. Now the rain gauge 50 is ready to collect rainwater and measure the height of rainwater through the previously mentioned method. As soon as the lowest conductor C1 of the rain gauge 50 is touched by rainwater, the microprocessor interrupts the automatic irrigation system which is connected to the first embodiment of the system 10 and starts displaying rainfall on an LCD. According to the algorithm shown in FIG. 16, if the height of rainwater inside the container 60 of the rain gauge 50 does not increase for a certain period of time, which is two hours in this case, the microprocessor will inform the automatic irrigation system of rainfall and will reactivate it. Then the microprocessor will inversely activate the electric motor 310 through the motor driver until the rain gauge 50 is rotated back to its downward facing position shown in FIG. 2 so that the gravitational force drains away the rainwater inside the container 60 through the opening 210 on the bottom 190 of the collector 170.

It should be mentioned that it is possible to precisely position the rain gauge 50 by means of a step motor together with a zero-backlash gearbox without using an encoder. However, if the gearbox has some backlash, then it will be necessary to use an encoder in order to precisely position the rain gauge 50.

Another noteworthy issue is that after that the rainwater inside the container 60 of the rain gauge 50 is drained away, the conductors C1 to Ck which were in touch with the rainwater will remain wet for a few minutes. As a result, the rain gauge 50 will suffer from a considerable amount of error until all conductors C1 to Ck get dry. That is why the first embodiment of the system 10 is suitable for measuring rainfall in regions where the rainfall produced by, each continuous raining is less than about 20 cm.

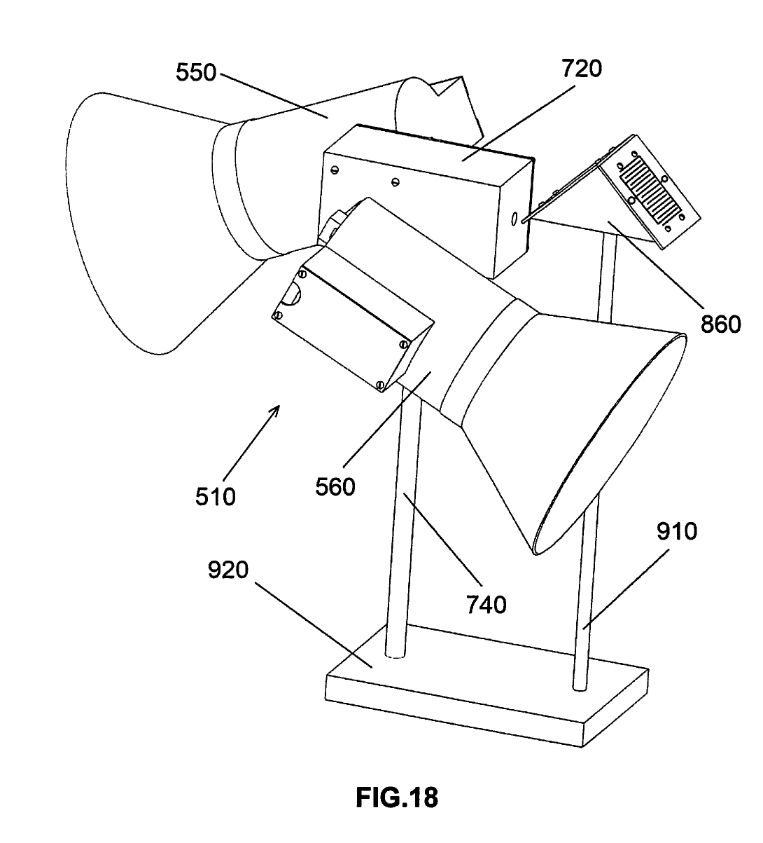

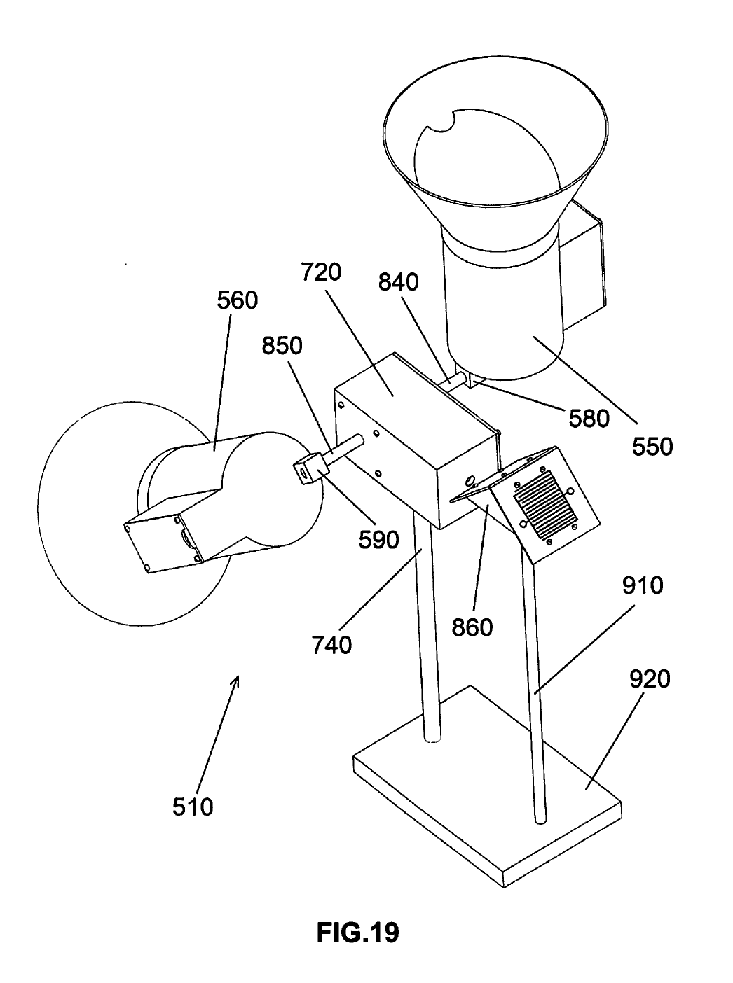

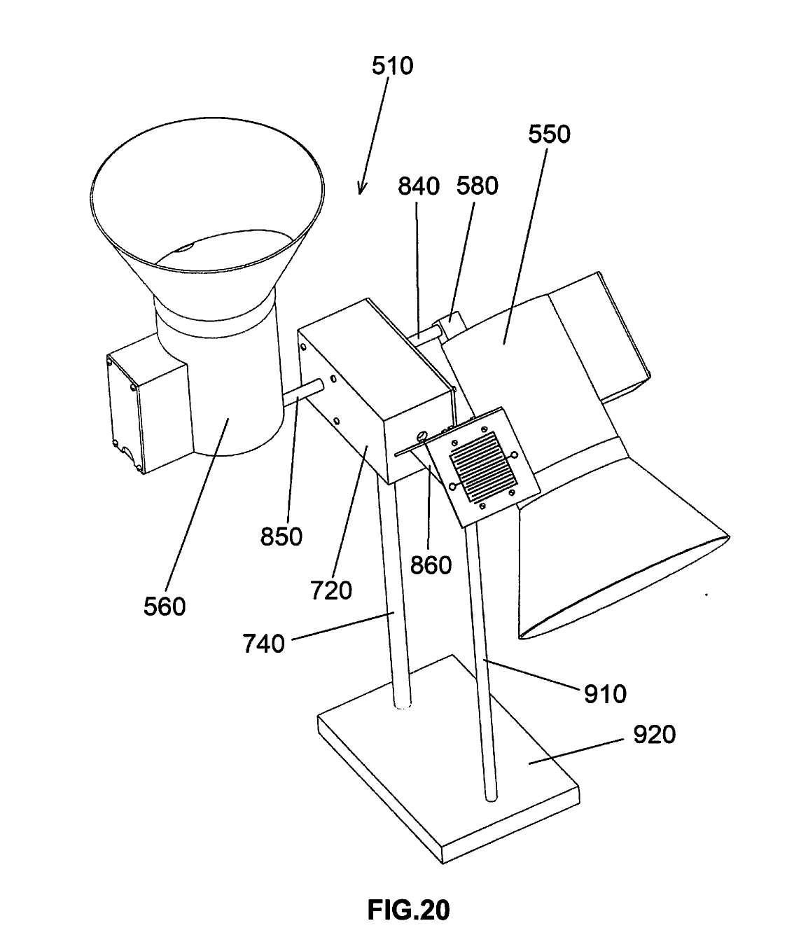

The second embodiment of the system 510, which has been illustrated in FIG. 18, FIG. 19 and FIG. 20, comprises two rain gauges 550 and 560, a motor housing 720, a rain detector 860 and a base 920. The rain gauges 550 and 560 of the second embodiment of the system 510 are attached to the motor shafts 840 and 850 through shaft mounts 580 and 590, which are fixed to the bottoms of the rain gauges 550 and 560. The motor housing 720 and the rain detector 860 can be permanently or temporarily fixed to the base 920 through support rods 740 and 910. That is, the support rods 740 and 910 may be screwed or welded to the base 920 or they may be a permanent part of the base 920.

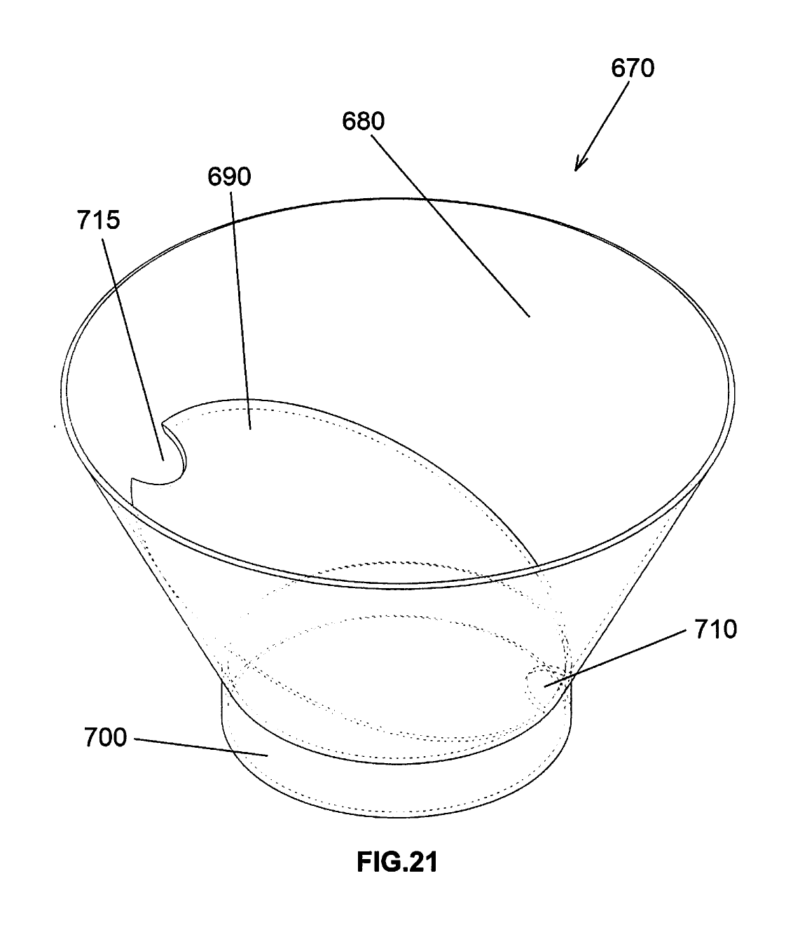

The structure of the rain gauges 550 and 560 of the second embodiment of the system 510 is almost identical to that of the rain, gauge 50 of the first embodiment of the system 10, with only two differences. The collector 670 of the rain, gauges 550 and 560, which has been illustrated in FIG. 21, comprises one more opening 715 on the highest part of its inclined bottom 690. This additional opening 715 is useful to drain away the rainwater inside the container of the rain gauges 550 and 560. That is, when the rain gauges 550 and 560 are in their downward facing positions, which have been illustrated in FIG. 8, FIG. 19, and FIG. 20 the rainwater inside the containers of rain gauges 550 and 560 can be drained away from either of the openings 715 or 710. Similar to the opening 710 which lies on the lowest part of the inclined bottom 690 of the collector 670, the additional opening 715 on the highest part of the inclined bottom 690 lies in a position away from the conductors so that the raindrops which pass through the additional opening 715 won't fall on the conductors. The second difference between the rain gauges 550 and 560 of the second embodiment of the system 510 and the rain gauge 50 of the first embodiment of the system 10 is that the containers of the rain gauges 550 and 560 of the second embodiment of the system 510 include one more shield which is located between the area where raindrops fall through the additional opening 715 and the conductors. Similar to the shield 135 of the rain gauge 50 of the first embodiment of the system 10, the additional shield should be as thin as possible so that it does not occupy a considerable volume of the rain gauges 550 and 560. Similarly, assuming that the manufacturing error of the various components of the rain gauges 550 and 560 and the error of the control circuitry 930 are equal to zero, the maximum error of the rain gauges 550 and 560 will be the same as the maximum error of the rain gauge 50 of the first embodiment of the system 10 which is equal to d(D₁/D₂)², where d, D₁, and D₂ were previously explained when determining the maximum error of the rain gauge 50 of the first embodiment of the system 10.

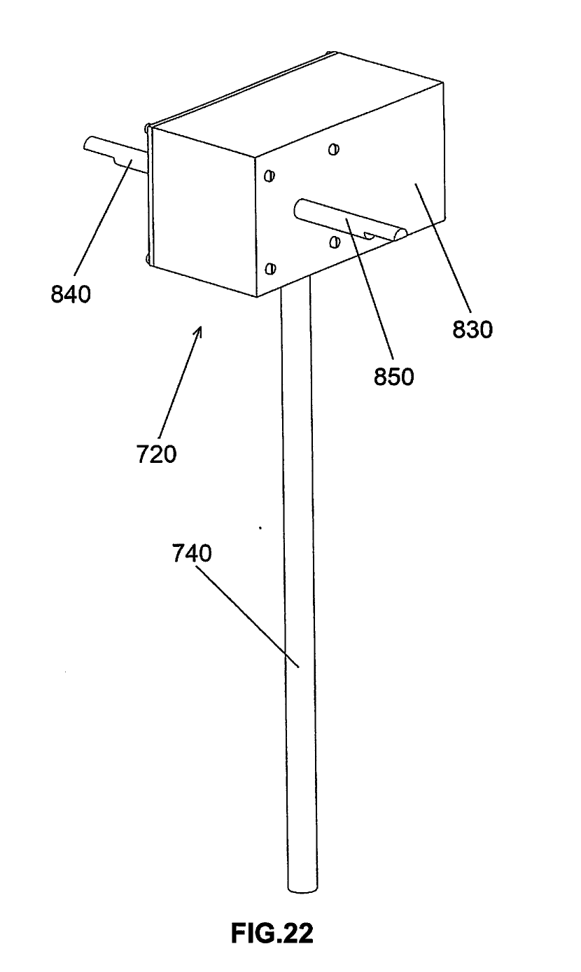

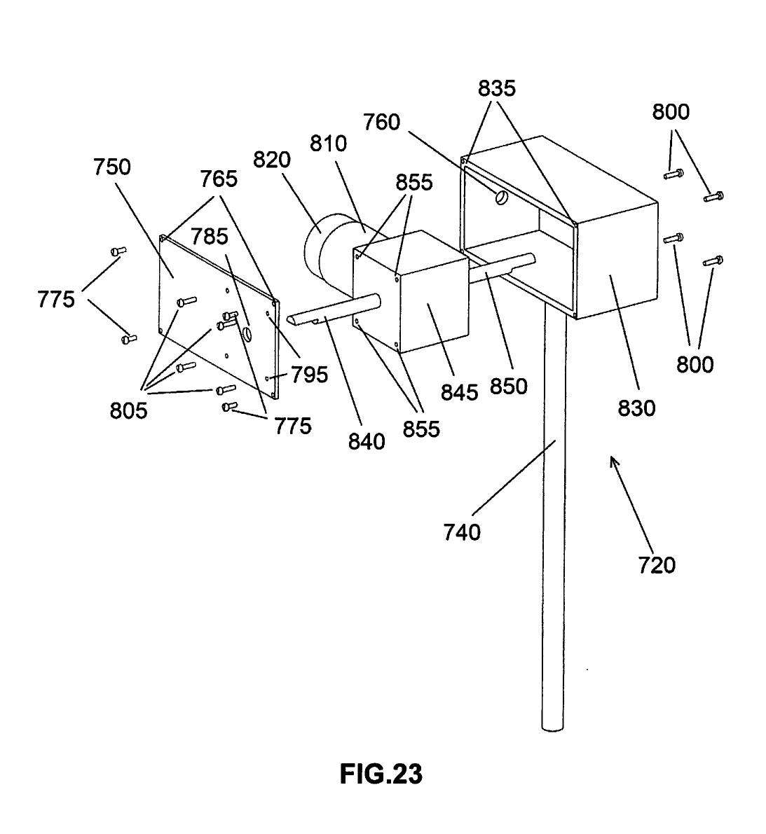

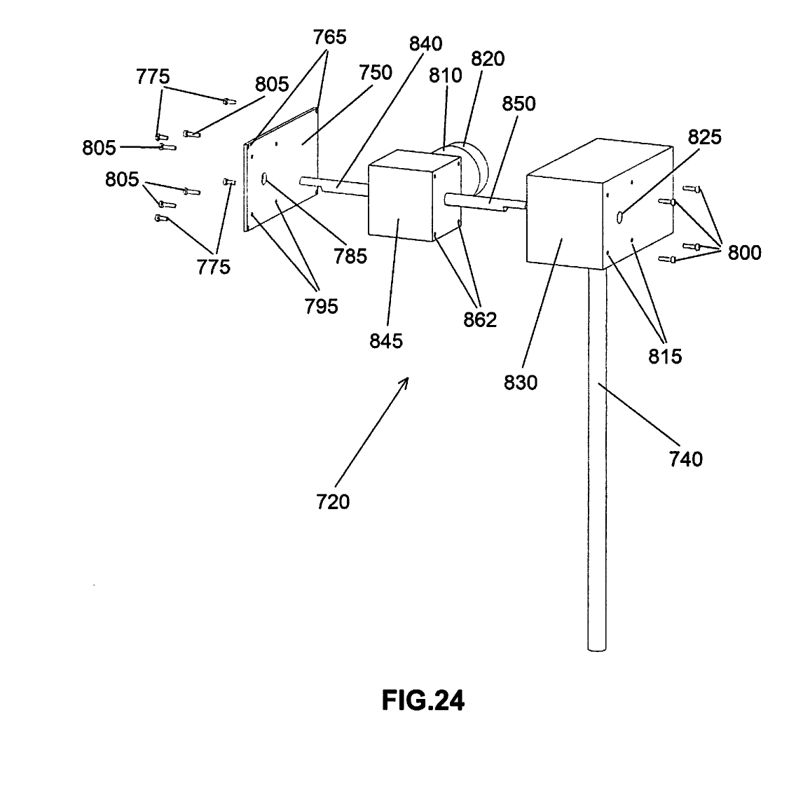

The motor housing 720 illustrated in FIG. 22, FIG. 23, and FIG. 24 comprises a box 830, a support rod 740, and a lid 750. The box 830 of the motor housing 720 includes part of the electronic circuitry 930, which is not shown in FIG. 22, FIG. 23, and FIG. 24, an electric motor 810 with a dual gearbox 845, two shafts 840 and 850, and an encoder 820. The box 830 of the motor housing 720 shown in FIG. 22, FIG. 23 and FIG. 24 has been designed to protect its contents from rain and other possible damaging causes. However, the motor housing 720 may be in other suitable shapes such as cylindrical. The electric motor 810 can be attached to the box 830 of the motor housing 720 through a plurality of screws 805 and 800 and screw holes 795, 855, 815, and 862 or by other suitable fasteners and methods. Two shaft holes 785 and 825 on the side faces of the box 830 allow the shafts 840 and 850 of the electric motor 810 to come out of the box 830 so that they can be fastened to the shaft mounts 580 and 590 of the rain gauges 550 and 590. The lid 750 of the motor housing 720 can be attached to the box 830 through a plurality of screws 775 and screw holes 765 and 838 or other fasteners or methods. An opening 760 has been provided on the rear face of the box 830 so that wires which connect the rain detector 860 and the circuits of the rain gauges 550 and 560 to the circuit inside the box 830 of the motor housing 720 can pass through the opening 760. The support rod 740 of the motor housing 720 may be screwed into the box 830 or it can be fixed to the box 830 by other fasteners and methods. The motor housing 720 can be made of aluminum to be light and corrosion-resistant or it can be made of other suitable materials such as hard plastic. The gear ratios of the dual gearbox 845 are equal so that both shafts 840 and 850 rotate with the same angular speeds and angular accelerations.

The rain detector 860 of the second embodiment of the system 510 is identical to the rain detector 360 of the first embodiment of the system 10, which was explained in details.

The base 920 of the second embodiment of the system 510 is the same as the base 420 of the first embodiment of the system 10 which was previously described.

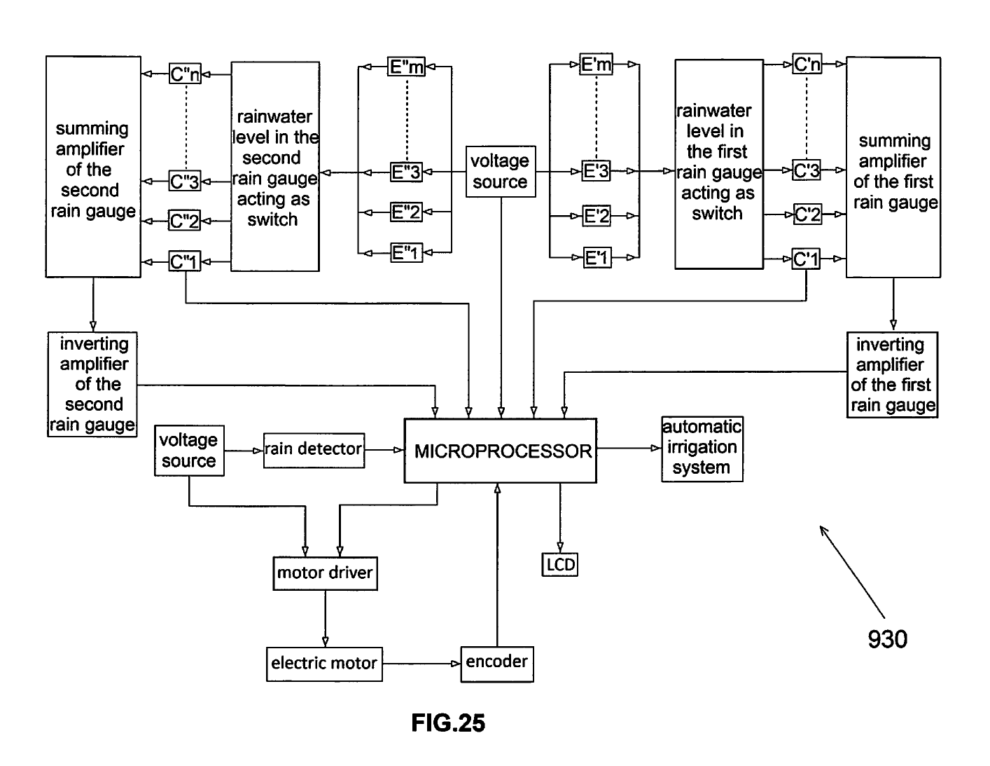

The control circuitry 930 of the second embodiment of the system 510 has been illustrated in FIG. 25. The control circuitry 930 of the second embodiment of the system 510 comprises DC voltage sources, the plurality of electrodes of the first rain gauge 550 designated by E1 to E′m, the plurality of electrodes of the second rain gauge 560 designated by E″1 to E″m, the plurality of conductors of the first rain gauge 550 designated by C′1 to C′n, the plurality of conductors of the second rain gauge 560 designated by C″1 to C″n, the rainwater inside the first rain gauge 550, the rainwater inside the second rain gauge 560, the summing amplifier of the first rain gauge 550, the summing amplifier of the second rain gauge 560, the inverting amplifier of the first rain gauge 550, the inverting amplifier of the second rain gauge 560, a rain detector 860, a microprocessor, a motor driver, an electric motor 810, an encoder 820, and an LCD. As it is observed from FIG. 25, the electrodes E′1 to E′m and E″1 to E″m are connected to a DC voltage source. As the level of rainwater rises inside the container of the vertically positioned rain gauge 550 or 560, rainwater successively connects the conductors C′1 to C′n or C″1 to C″n of the vertically positioned rain gauge 550 or 560 to the electrodes E′1 to E′m or E″1 to E″m of the vertically positioned rain gauge 550 or 560. Consequently, among the conductors C′1 to C′n or C″1 to C″n of the vertically positioned rain gauge 550 or 560, those which are touched by rainwater receive equal voltages from the electrodes E′1 to E′m or E″1 to E″m and transfer the voltages to the summing amplifier of the vertically positioned rain gauge 550 or 560 through wires as shown in FIG. 15. The summing amplifiers and the inverting amplifiers of the first and second rain gauges 550 and 560 are identical to the summing amplifier and the inverting amplifier of the rain gauge 50 of the first embodiment of the system 10, which were previously explained in details. The method which is used by the microprocessor to determine water level in the containers of the first and second rain gauges 550 and 560 is the same as the method used by the microprocessor of the first embodiment of the system 10 and was explained in details when describing the control circuitry 430 of the first embodiment of the system 10. However, the operation of the control circuitry 930 of the second embodiment of the system 510, which will be explained in details in the next paragraph, is slightly different from the operation of the control circuitry 430 of the first embodiment of the system 10.

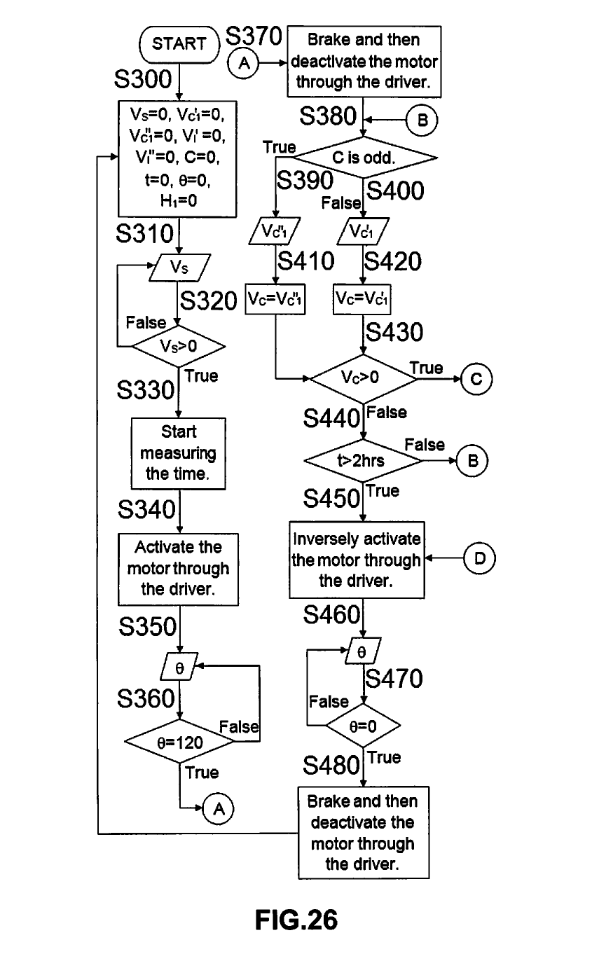

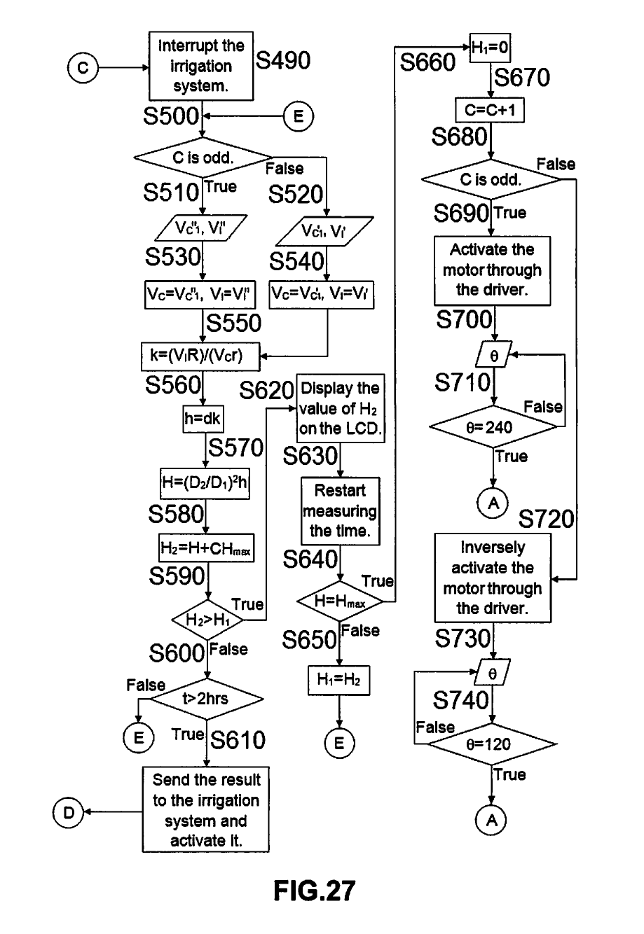

FIG. 26 and FIG. 27 illustrate an algorithm which can be used by the microprocessor to run the second embodiment of the system 510. Using this algorithm, the microprocessor interrupts an automatic irrigation system, which is connected to the second embodiment of the system 510, measures rainfall, displays rainfall, which is measured in depth, on an LCD, informs the automatic irrigation system of rainfall and communicates with the motor driver and the encoder 820 to precisely position the rain gauges 550 and 560. In the algorithm shown in FIGS. 26 and 27, it has been assumed that the rain gauges 550 and 560 are apart from each other by an angle of 120 degrees and both are initially inclined downward so that the first rain gauge 550 is inclined from its vertical position by an angle of 120 degrees (FIG. 18). However, the angle between the two rain gauges 550 and 560 may be chosen to be any other suitable angle. Note that most of the equations and formulas which have been used in the algorithm shown in FIG. 26 and FIG. 27 were previously explained in details when describing the control circuitry 430 of the first embodiment of the system 10. That is why only new equations of the algorithm shown in FIG. 26 and FIG. 27, which were not used in the algorithm shown in FIG. 16 and FIG. 17, will be explained here. Assume that V_{C′1} is the voltage of the lowest conductor C′1 of the first rain gauge 550, V_{C″1} is the voltage of the lowest conductor C″1 of the second rain gauge 560, V_{I′} is the output voltage of the inverting amplifier of the first rain gauge 550, V_{I″} is the output voltage of the inverting amplifier of the second rain gauge 560, 0 is the angular position of the first shaft 840 (note that since the gear ratios for both shafts 840 and 850 are equal, their angular speeds will be equal too.), C is the counter, and Hₘₐₓ is the maximum height of the rainwater which can be measured by each of the rain gauges 550 and 560. Other parameters and variables used in the algorithm illustrated in FIG. 26 and FIG. 27 are the same as the parameters and variables which were used in the algorithm which was previously presented to run the first embodiment of the system 10 and were previously defined. In step S300 of the algorithm, shown in FIG. 26, the values of V_{S}, V_{C′1}, V_{C″1}, V_{I′}, V_{I″}, C, t, θ, and H₁ are set equal to zero. In step S310, the voltage received from the rain detector 860 is measured. In step S320, it is decided if the voltage received from the rain detector 860 is greater than zero or not. If the voltage received from the rain detector 860 is not greater than zero, it means that it is not raining. In this case, the microprocessor keeps measuring the voltage received from the rain detector 860 and comparing its value with zero. But if the voltage received from the rain detector 860 is greater than zero, then the microprocessor goes to step S330 of the algorithm and starts measuring the time. In step S340, the electric motor 810 is activated through the motor driver. As the shafts 840 and 850 start rotating, the angular position of the first shaft 840 is measured through the encoder 820 in step S350. Then in step S360 of the algorithm shown in FIG. 26, it is decided if the angular position of the first shaft 840 is equal to the desired value, which has been chosen to be 120 degrees in this case. When the angular position of the first shaft 840 reaches 120 degrees, the first rain gauge 550 will be in its vertical position and the second rain gauge 560 will be inclined downward by an angle of 120 degrees from the first rain gauge 550 (FIG. 19). In this case, the motor driver brakes and stops the motor 810 in Step S370. Then in step S380, the microprocessor decides if the value of the counter is odd or even. If the value of the counter is an even number, it means that the first rain gauge 550 lies in its vertical position collecting and measuring rainfall, and the second rain gauge 560 lies in its downward facing position (FIG. 19). But if the value of the counter is an odd number, it means that the second rain gauge 560 is in its vertical position collecting and measuring rainfall, and the first rain gauge 550 lies in its second downward facing position (FIG. 20). Once that the microprocessor recognizes the rain gauge 550 or 560 which lies in the vertical position, it measures the voltage of the lowest conductor C′1 or C″1 of the vertical rain gauge 550 or 560 in step S390 or S400. The measured value of the voltage received from the lowest conductor C′1 or C″1 is assigned to V_{C} in step S410 or S420. Then it is decided if the value of V_{C} is greater than zero or not. If the value of V_{C} is not greater than zero, the microprocessor checks the measured time in step S440. If the measured time is less than two hours, the microprocessor returns to step S380 and keeps measuring the voltage of the lowest conductor C′1 or C″1 of the vertical rain gauge 550 or 560 and comparing it with zero. But if the measured time is greater than two hours, that is, if the voltage of the lowest conductor C′1 or C″1 remains equal to zero for two hours, it means that it is not raining and the electrical signal sent by the rain detector 860 was the result of an accidental water spill on the rain sensors. In this case, the microprocessor goes to step S450 and inversely activates the electric motor 810. As a result, the rain gauges 550 and 560 are rotated back to their initial downward facing positions shown in FIG. 18. The angular position of the first shaft 840 is continuously measured by an encoder 820 and is compared with zero by the microprocessor in steps S460 and S470. When the angular position of the first shaft 840 becomes equal to zero, the rain gauges 550 and 560 will be in their initial downward facing positions shown in FIG. 18. In this case, the microprocessor brakes and then deactivates the electric motor 810 through the motor driver. Then the microprocessor goes back to step S300 and restarts applying the algorithm shown in FIG. 26 and FIG. 27. If in step S430 the microprocessor decides that the value of V_{C} is greater than zero, then it means that it is raining and some rainwater has been collected by the container of the vertical rain gauge 550 or 560. In this case, the microprocessor goes to step S490 and interrupts the automatic irrigation system. Then in step S500, the value of the counter is checked. If the value of the counter is an even number, it means that the first rain gauge 550 is in its vertical position to collect and measure rainfall (FIG. 19). Consequently, the microprocessor measures the voltage of the lowest conductor C′1 of the first rain gauge 550 and the output voltage of the inverting amplifier of the first rain gauge 550 in step S520 and assigns them to V_{C} and V_{I} respectively in step S540. But if the value of the counter is an odd number, it means that the second rain gauge 560 is in its vertical position to collect and measure rainfall (FIG. 20). Consequently, the microprocessor measures the voltage of the lowest conductor C″1 of the second rain gauge 560 and the output voltage of the inverting amplifier of the second rain gauge 560 in step S510 and assigns them to V_{C} and V_{I} respectively in step S530. Note that although the voltage of the lowest conductor C′1 or C″1 of the vertical rain gauge 550 or 560 was previously measured in step S390 or step S400, it is necessary to measure the voltage of the lowest conductor C′1 or C″1 of the vertical rain gauge 550 or 560 once again in step S520 or S510. The reason behind updating the voltage of the lowest conductor C′1 or C″1 of the vertical rain gauge 550 or 560 was previously explained when describing step S170 of the algorithm shown in FIG. 16 and FIG. 17. In step S550, the number of the conductors C′1 to C′k or C″1 to C″k of the vertical rain gauge 550 or 560 which are touched by rainwater is determined through equation k=(RV₁)/(rV_{C}). In step S560, the height of the rainwater inside the vertical rain gauge 550 or 560, h, is calculated according to the number of the conductors C′1 to C′k or C″1 to C″k which are touched by rainwater through equation h=dk, and then the corresponding portion of the current rainfall, H, is calculated in step S570 through H=(D₂/D₁)²h. Finally the current total rainfall, H₂, is determined in step S580 through H₂=H+CHₘₐₓ. Note that in the present equation, the value of the counter, C, indicates the number of times that the height of rainwater inside rain gauges 550 and 560 has reached the maximum capacity of the rain gauges 550 and 560. For example, if C=2, it means that the first and second rain gauges 550 and 560 were successively filled up of rainwater and emptied once. In other words, in equation presented in step S580, CHₘₐₓ reflects the height of rainwater which has filled up the rain gauges 550 and 560 for C times. Then in step S590, it is decided if the currently calculated total rainfall, H₂, is greater than the formerly calculated one, H₁, or not. If the currently calculated total rainfall is not greater than the formerly calculated one, the microprocessor checks the measured time in step S600 to decide if the measured time is greater than two hours or not. If the measured time is not greater than two hours, then the microprocessor returns to step S500 and repeats steps S500 to S590 in order to update the value of H₂ and compare it with H₁. But if the measured time is greater than two hours, it means that there has been no increase in rainfall during the last two hours, which means that it has stopped raining. In this case, the microprocessor goes to step S610 and informs the automatic irrigation system of the final value of the total rainfall. Then the microprocessor goes to step S450 and performs the previously mentioned operations to rotate the rain gauges 550 and 560 back to their initial downward facing positions shown in FIG. 18 and restarts the algorithm in step S300. If in step S590, the currently calculated total rainfall, H₂, is greater than the formerly calculated total rainfall, H₁, then in step S620, the value of the currently calculated rainfall is displayed on the LCD and the microprocessor restarts measuring the time in step S630. In step S640, it is decided if the height of the rainwater inside the container of the vertical rain gauge 550 or 560 is equal to the maximum measurable height of rainwater or not. If the height of the rainwater inside the container of the vertical rain gauge 550 or 560 is not equal to the maximum measurable height of rainwater, then the value of H₂ is assigned to H₁ in step S650, and the microprocessor goes back to step S500 to update the value of the current rainfall, H₂ through steps S500 to S590 and compare it with H₁. But if the height of the rainwater inside the container of the vertical rain gauge 550 or 560 is equal to the maximum measurable height of rainwater, then it means that the container of the vertical rain gauge 550 or 560 has been filled up with rainwater. In this case, the value of H₁ is reset equal to zero in step S660, and the value of the counter is increased by unity in step S670. Then in step S680, it is decided if the value of the counter is an odd number or an even number. If the value of the counter is an odd number, it means that the first rain gauge 550 lies in its vertical position measuring rainfall, and the second rain gauge 560 is inclined downward (FIG. 19). In this case, the microprocessor activates the electric motor 810 through the motor driver in step S690 and measures the angular position of the first shaft 840 through the encoder 820 in step S700. In step S710, it is decided if the angular position of the first shaft 840 has reached 240 degrees or not. As long as the angular position of the first shaft 840 has not reached 240 degrees, the microprocessor keeps running the electric motor 810 and measuring the angular position of the first shaft 840 through the encoder 820. When the angular position of the first shaft 840 reaches 240 degrees, the second rain gauge 560 will be in its vertical position measuring rainfall and the first rain gauge 550 will be inclined downward so that the rainwater inside the first rain gauge 550 will be drained away through the opening 710 (FIG. 20). Then, the microprocessor goes back to step S370 to measure the rest of rainfall by means of the second rain gauge 560. If in step S680 it is decided that the value of the counter is an even number, it means that the second rain gauge 560 lies in its vertical position measuring rainfall and the first rain gauge 550 is inclined downward (FIG. 20). In this case the microprocessor inversely activates the electric motor 810 through the motor driver in step S720 and measures the angular position of the first shaft 840 through the encoder 820 in step S730. In step S740, it is decided if the angular position of the first shaft 840 is equal to 120 degrees or not. As long as the angular position of the first shaft is not equal to 120 degrees, the microprocessor keeps inversely rotating the electric motor 810 and measuring the angular position of the first shaft 840. When the angular position of the first shaft 840 becomes equal to 120 degrees, the first rain gauge 550 will lie in its vertical position measuring rainfall and the second rain gauge 560 will be inclined downward so that the rainwater inside the second rain gauge 560 will be drained away through the opening 710 (FIG. 19). Then, the microprocessor goes back to step S370 to measure the rest of rainfall by means of the first rain gauge 550.

In order to operate the second embodiment of the system 510, the rain gauges 550 and 560 should initially lie in their downward facing positions as shown in FIG. 18. When the rain gauges 550 and 560 are inclined downward, the openings 710 and 715 on the bottom 690 of the collector 670 won't be blocked by external objects such as leaf, feather, dust, etc, and external objects won't enter the container of the rain gauges 550 and 560. As soon as a raindrop falls on a rain sensor of the rain detector 860, the rain detector 860 sends an electrical signal to the microprocessor. Then the microprocessor activates the electric motor 810 and consequently, the electric motor 810 rotates the rain gauges 550 and 560 through the gearbox 845 and the shafts 840 and 850. Obviously, the gearbox 845 is used in order to reduce the speed of the shafts 840 and 850 and to increase their torques. The microprocessor continuously measures the angular position of the first shaft 840 through the encoder 820. When the first rain gauge 550 reaches its vertical position shown in FIG. 19, the microprocessor brakes the electric motor 810 through the motor driver and then deactivates it. Now the first rain gauge 550 is ready to collect rainwater and measure the height of rainwater through the previously mentioned method. As soon as the lowest conductor C′1 of the first rain gauge 550 is touched by rainwater, the microprocessor interrupts the automatic irrigation system which is connected to the second embodiment of the system 510 and starts displaying rainfall on an LCD. According to the algorithm shown in FIG. 26 and FIG. 27, if the height of rainwater inside the container of the first rain gauge 550 does not increase for a certain period of time, which is two hours in this case, the microprocessor will inform the automatic irrigation system of the final rainfall and will reactivate it. Then the microprocessor will inversely activate the electric motor 810 through the motor driver until the first rain gauge 550 is rotated back to its initial downward facing position shown in FIG. 18 so that the gravitational force drains away the rainwater inside the container through the upper opening 715 on the bottom 690 of the collector 670. If rainfall is so high that the container of the first rain gauge 550 is filled up with rainwater, then the microprocessor will activate the electric motor 810 so that the second rain gauge 560 is rotated to its vertical position and the first rain gauge 550 is rotated to its second downward facing position (FIG. 20). In this case, the rainwater inside the container of the first rain gauge 550 is drained away by gravitational force through the lower opening 710 on the bottom 690 of the collector 670, and the second rain gauge 560 continues measuring rainfall. As long as it keeps raining, the rain gauges 550 and 560 will continue to measure rainfall in turn. In other words, when the container of the vertical rain gauge 550 or 560 is filled up with rainwater, the inclined rain gauge 550 or 560 will be rotated to its vertical position to measure rainfall and simultaneously the other rain gauge 550 or 560 which is filled up with rainwater will be rotated to its downward facing position so that the rainwater inside its container is drained away by gravitational force.

It should be mentioned that it is possible to precisely position the rain gauges 550 and 560 by means of a step motor together with a zero-backlash dual gearbox without using an encoder. However, if the dual gearbox has some backlash, then it will be necessary to use an encoder in order to precisely position the rain gauges 550 and 560.

Another noteworthy issue is that the second embodiment of the system 510 is able to precisely measure all ranges of rainfalls from very high rainfalls to very low rainfalls. However, because of its higher price in comparison to the first embodiment of the system 10, it is recommended to be used in regions with high and very high rainfalls.

Although the present invention and its advantages have been described in details, it should be understood that various changes, substitutions, and alterations can be made herein without departing from the spirit and scope of the design as defined by the appended claims. Moreover, the scope of the present application is not intended to be limited to the particular embodiments, algorithms, and methods described in the specification. As one of ordinary skill in the art will readily appreciate from the present disclosure that processes, machines, means, methods, and algorithms to be developed later which will perform substantially the same function or will achieve the same results as described through the corresponding embodiments herein, may be utilized according to the present disclosure. Accordingly, the appended claims are intended to include within their scope such processes, machines, means, methods, and algorithms.

What is claimed is:

1) A rainfall measurement system comprising:
at least one pivoting rain gauge which collects rain and measures rainfall when in a vertical position and which remains in a downward facing position in absence of rain;
a motor coupled to the pivoting rain gauge;
a control circuitry connected to the motor and to the pivoting rain gauge;
a display connected to the control circuitry which displays the measured rainfall; and
at least one rain detector connected to the control circuitry, where in response to the rain detector detecting the rainfall, the control circuitry makes the motor rotate the pivoting rain gauge from the downward facing position to the vertical position.

2) The rainfall measurement system of claim 1, wherein upon determining cease of the rain, the control circuitry makes the motor rotate the pivoting rain gauge from the vertical position to the downward facing position.

3) The rainfall measurement system of claim 2, wherein gravity makes the collected rain drain out of the pivoting rain gauge when the pivoting rain gauge is in the downward facing position.

4) The rainfall measurement system of claim 3, wherein the control circuitry is further connected to an automatic irrigation system and wherein upon determining start of the rain, the control circuitry interrupts a program of the automatic irrigation system.

5) The rainfall measurement system of claim 4, wherein upon determining the cease of the rain, the control circuitry sends data indicating the measured rainfall to the automatic irrigation system.

6) The rainfall measurement system of claim 3, wherein the control circuitry is further connected to a weather monitoring system and wherein upon determining start of the rain, the control circuitry sends data indicating the measured rainfall to the weather monitoring system.

7) The rainfall measurement system of claim 5, wherein the pivoting rain gauge comprises:
a rain collector which collects the rain;
a plurality of conductors and a plurality of electrodes which together measure a level of the collected rain.

8) The rainfall measurement system of claim 7, wherein the control circuitry calculates the rainfall based on the measured level of the collected rain.

9) An electronic circuitry to measure a level of a conductive liquid in a container comprising:
a voltage source;
a plurality of electrodes connected to the voltage source;
a plurality of conductors;
a summing amplifier connected to the plurality of conductors;
an inverting amplifier connected to the summing amplifier; and
a microprocessor connected to the inverting amplifier.

10) The electronic circuitry of claim 9, wherein the conductors are arranged in columns which travel up the container and where in each column, each conductor is at a constant predetermined distance from an adjacent conductor.

11) The electronic circuitry of claim 10, wherein each electrode is placed between two columns of conductors and at an equal distance from each of the two columns of electrodes.

12) The electronic circuitry of claim 11, wherein the plurality of conductors are equally electrified while in contact with the conductive liquid.

13) The electronic circuitry of claim 12, wherein the summing amplifier receives a voltage from each of the equally electrified conductors.

14) The electronic circuitry of claim 13, wherein an output voltage of the summing amplifier is received by the inverting amplifier.

15) The electronic circuitry of claim 14, wherein the output voltage of the inverting amplifier is received by the microprocessor.

16) The electronic circuitry of claim 15, wherein the microprocessor calculates the level of the conductive liquid according to the voltage received from the inverting amplifier and according to the predetermined distance between adjacent conductors in each column of conductors.

17) A method of operating a rainfall measurement system which includes a pivoting rain gauge, a motor coupled to the pivoting rain gauge, a control circuitry connected to the pivoting rain gauge and to the motor, a display connected to the control circuitry, and a rain detector connected to the control circuitry, the method comprising successive steps of:
detecting rain through a signal received from the rain detector by the control circuitry;
activating the motor through a signal sent by the control circuitry to the motor until the motor rotates the pivoting rain gauge from a downward facing position to a vertical position;
measuring rainfall through the pivoting rain gauge when the pivoting rain gauge is in the vertical position;
displaying the measured rainfall on the display through sending data signals from the control circuitry to the display;
determining cease of rain through a threshold period of time during which the measured rainfall remains unchanged;
inversely activating the motor through a signal sent by the control circuitry to the motor until the motor rotates the pivoting rain gauge from the vertical position to the downward facing position.
